(19) United States
(12) Patent Application Publication
(10) Pub. No.: US 2020/0082465 A1
(43) Pub. Date: Mar. 12, 2020

(54) METHOD AND SYSTEM TO GENERATE A MULTI-PANEL UI BASED ON HIERARCHY DATA CORRESPONDING TO DIGITAL CONTENT

(71) Applicant: Yi Li, Montreal (CA)

(72) Inventor: Yi Li, Montreal (CA)

(21) Appl. No.: 16/128,280

(22) Filed: Sep. 11, 2018

(51) Int. Cl. G06Q 30/06; G06F 9/451; G06F 3/0482

(52) U.S. Cl. CPC G06Q 30/0643; G06F 2203/04803; G06F 3/0482; G06F 9/451

(57) ABSTRACT

A method to facilitate generation of a multi-panel UI based on a hierarchy data corresponding to a digital content is disclosed. The method may include receiving, using a communication device, the hierarchy data corresponding to the digital content from a computing device. Further, the method may include generating, using a processing device, the multi-panel UI based on the hierarchy data. The multi-panel UI may include a plurality of panels corresponding to a plurality of levels of hierarchy. Further, each panel of the plurality of panels may include a visual representation of a plurality of categories associated with a corresponding level of hierarchy. Further, the method may include storing, using a storage device, the multi-panel UI. Further, the method may include transmitting, using the communication device, the multi-panel UI to a user device. Further, the user device may be configured to render the multi-panel UI.

### FIELD OF THE INVENTION

The present disclosure relates generally to the field of data processing. More specifically, the present disclosure describes methods and systems to generate a multi-panel ui based on hierarchy data corresponding to digital content.

### BACKGROUND OF THE INVENTION

Multiple e-commerce platforms exist nowadays that allow users to procure desired products. However, users may need to navigate through multiple pages to place orders from most e-commerce platforms. Further, users may need to navigate through multiple pages to change settings and filters, and even to receive or send messages through the platforms in the website.

Further, in most e-commerce platforms, layouts used to display products may include an index on one side along. Further, to notify users in which category and/or sub-category the uses may be browsing, logical traces displaying clicked sequences may be displayed in a string in a location on a webpage.

Further, search and sorting interface used by e-commerce platforms is unfriendly with users having to manually describe a category in which a search or sorting operation may be performed.

Further, ordered products are displayed in lists in shopping cars. Accordingly, if a user wishes to change an amount of an ordered product, the user may have to click on the individual product, and may have to navigate multiple pages to change an amount or quantity of the individual product.

Further, delivery time for orders is often provided in a list. As such, if there are multiple orders in a day, a user may have difficulty in rearranging a delivery schedule and inserting an order at the middle of the schedule.

Therefore, there is a need for improved methods and systems to generate a multi-panel ui based on hierarchy data corresponding to digital content that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method to generate a multi-panel UI based on hierarchy data corresponding to digital content is disclosed. Accordingly, the method may include receiving, using a communication device, hierarchy data corresponding to a digital content from a user device. Further, the method may include generating, using a processing device, a multi-panel UI based on the hierarchy data. Further, the method may include storing, using a storage device, the generated multi-panel UI. Further, the method may include transmitting, using a communication device, the multi-panel UI to one or more user devices.

Further, according to some embodiments, a system to facilitate generation of a multi-panel UI based on a hierarchy data corresponding to a digital content is also disclosed. The system may include a communication device configured for receiving the hierarchy data corresponding to the digital content from a computing device and transmitting the multi-panel UI to a user device. Further, the system may include a processing device configured for generating the multi-panel UI based on the hierarchy data. Further, the system may include a storage device configured for storing the multi-panel UI.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a flowchart of a method to generate a multi-panel UI based on hierarchy data corresponding to digital content, in accordance with some embodiments.

FIG. 3 shows a flowchart of a method to generate a multi-panel UI based on hierarchy data corresponding to digital content, in accordance with some embodiments.

FIG. 4 shows a flowchart of a method to configure a visual configuration of a multi-panel UI based on a display configuration of a user device, in accordance with some embodiments.

FIG. 5 shows a flowchart of a method to manipulate a multi-panel UI based on a sensory information of a user device, in accordance with some embodiments.

FIG. 6 shows a flowchart of a method to manipulate a multi-panel UI based on analysis of interaction data, in accordance with some embodiments.

FIG. 7A shows an exemplary shopping interface, showing popular products, in accordance with some embodiments.

FIG. 7B shows an exemplary shopping interface, showing categories of products, in accordance with some embodiments.

FIG. 8 shows exemplary sorting buttons in opposite directions, in accordance with some embodiments.

FIG. 9A shows an exemplary shopping interface that displays multiple products with names in rows and columns, in accordance with some embodiments.

FIG. 9B shows an exemplary shopping interface with a panel displaying products belonging to a category, in accordance with some embodiments.

FIG. 9C shows an exemplary shopping interface with a panel displaying a selected product, in accordance with some embodiments.

FIG. 10A illustrates a mechanism to display additional overlapping panels in a shopping interface, in accordance with some embodiments.

FIG. 10B illustrates a mechanism to successively close a chain of overlapping panels in a shopping interface, in accordance with some embodiments.

FIG. 10C illustrates a mechanism to close a chain of overlapping panels in a shopping interface from any position, in accordance with some embodiments.

FIG. 11 shows a setting panel of a shopping interface, in accordance with some embodiments.

FIG. 12 shows a message panel of a shopping interface, in accordance with some embodiments.

FIG. 13 shows a shopping cart of a shopping interface, in accordance with some embodiments.

FIG. 14A shows a panel to select delivery time of one or more products of a shopping interface, in accordance with some embodiments.

FIG. 14B shows a panel to view scheduled orders of a shopping interface, in accordance with some embodiments.

FIG. 15 shows a failed delivery section of a shopping interface, in accordance with some embodiments.

FIG. 16A shows an exemplary search panel of a shopping interface, in accordance with some embodiments.

FIG. 16B shows an exemplary panel of a shopping interface rearranged based on previous interaction with the shopping interface, in accordance with some embodiments.

FIG. 17 shows a panel of a shopping interface including a “My favorites” category, in accordance with some embodiments.

FIG. 18A shows an exemplary shopping interface including a panel opening on top of an existing panel, in accordance with some embodiments.

FIG. 18B shows an exemplary shopping interface including second panel opening on top of a first panel, with a shrunk first panel, in accordance with some embodiments.

FIG. 19 shows an exemplary shopping interface including a fixed number of panels, in accordance with some embodiments.

FIG. 20 shows a delete button and a go-top button of an exemplary shopping interface, in accordance with some embodiments.

FIG. 21 shows a touch symbol in an exemplary shopping interface, in accordance with some embodiments.

FIG. 22 shows a side bar in an exemplary shopping interface, in accordance with some embodiments.

FIG. 23 shows an exemplary shopping interface with multiple clicked panels, displaying a fixed number of panels, in accordance with some embodiments.

FIG. 24 shows a close button beside panels in an exemplary shopping interface, in accordance with some embodiments.

FIG. 25 shows symbols atop clicked panels, describing the clicked panels, in an exemplary shopping interface, in accordance with some embodiments.

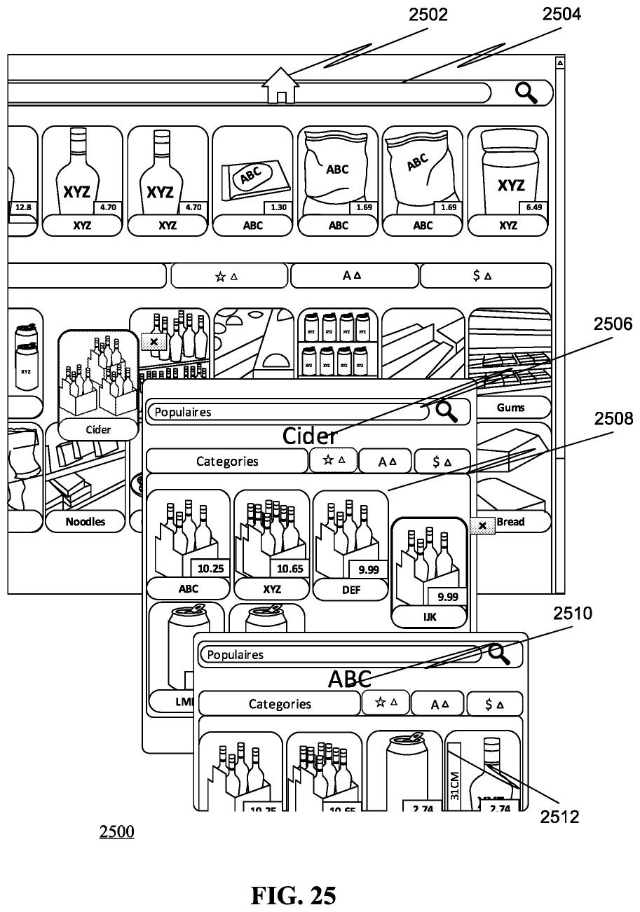

FIG. 26 shows an exemplary multi-panel UI, showing a first form, and a second form of panels, in accordance with some embodiments.

FIG. 27 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of generation of a multi-panel UI based on hierarchy data corresponding to digital content, embodiments of the present disclosure are not limited to use only in this context.

Overview

A visually refined shopping interface may enable users to search and select products in a single webpage and may allow a user to change settings and place an order through the same webpage.

The products may be displayed in a serial of partially overlapping hierarchical panels. Each time the user selects a product, the product may change position and a new panel may be displayed to form a new top layer of the webpage, representing sub-content or detail of a chosen product. Further, the new top layer may cover a part of the rest products. Further, in an embodiment, one or more panels including the rest of the products may undergo other visual modification, such as fading, shrinking, and so on to accommodate the new top layer.

Further, if the content of the new top layer is clicked, another new top layer may be displayed, thus forming a chain of panels which may sequentially cover a part of the one or more previous panels to display a clicking sequence of a user. Further, a user may click on a partially covered panel to conveniently go back to the previous selection.

In every panel, a search button, and a set of sort buttons, which may enable the users to search and/or sort products within a current panel may be present.

Further, a shopping cart may be displayed on the webpage, with one or more image representations of selected products. Further, users may be able to adjust quantities of the selected products accordingly.

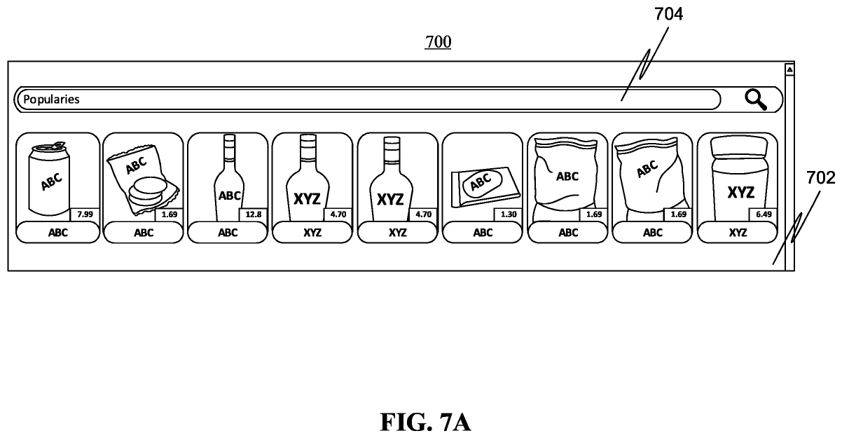

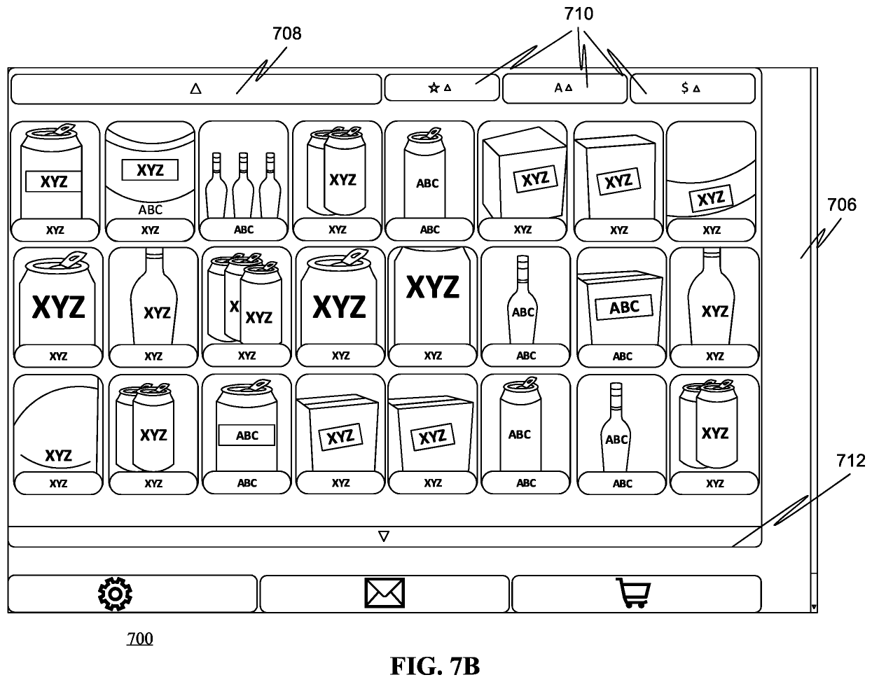

FIGS. 7A and 7B show an exemplary shopping interface 700, comprising a panel with two sections. The first section 702 may display most popular products and the second section 706 may display categories of products and less popular products. Further, the first section 702 may include a search bar 704 on top that may allow a user to input keywords for searching and screening.

Further, the second section 706 may include a button 708 with an upward symbol that may be used for navigation upward, a button 712 with a downward symbol that may be used for navigation downward, and three sort buttons 710 to sort products according to filters such as popularity, alphabet, price, and so on.

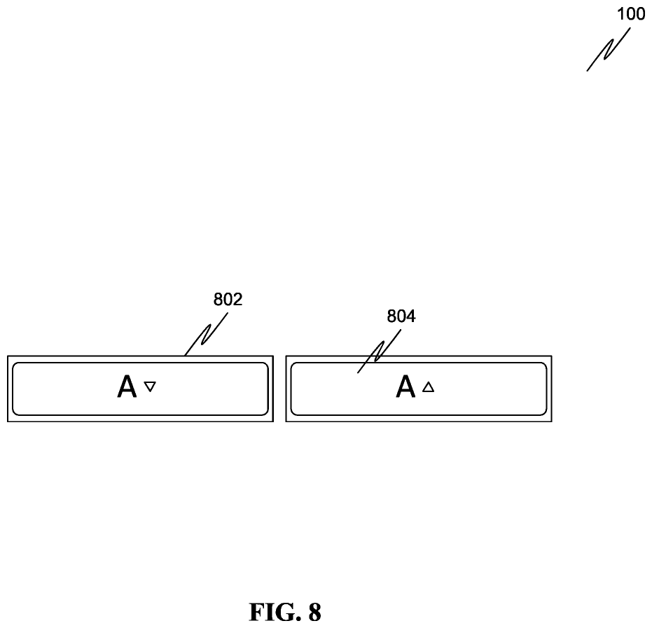

Further, by clicking the sort buttons 710, sorting directions may be interchanged. FIG. 8 shows exemplary sorting buttons 802 and 804 in opposite directions.

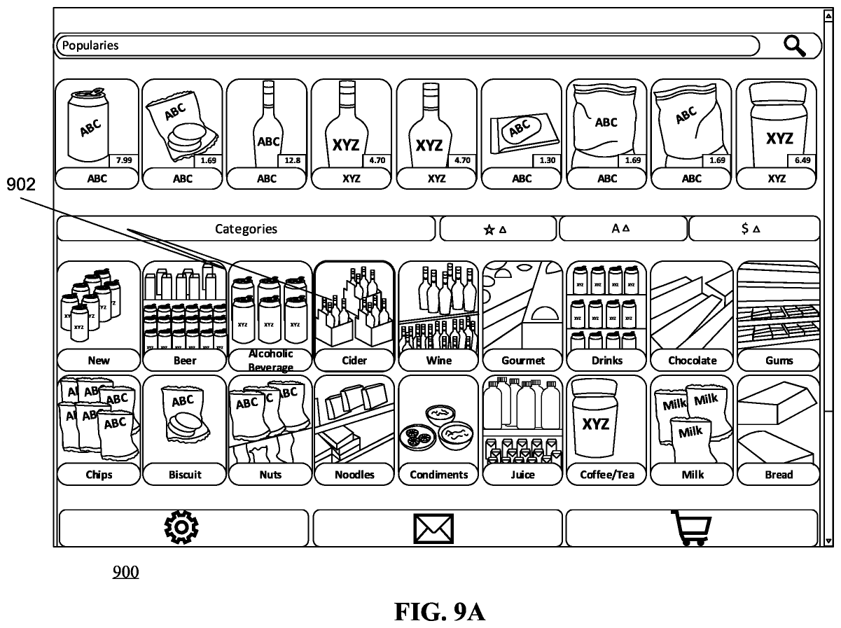

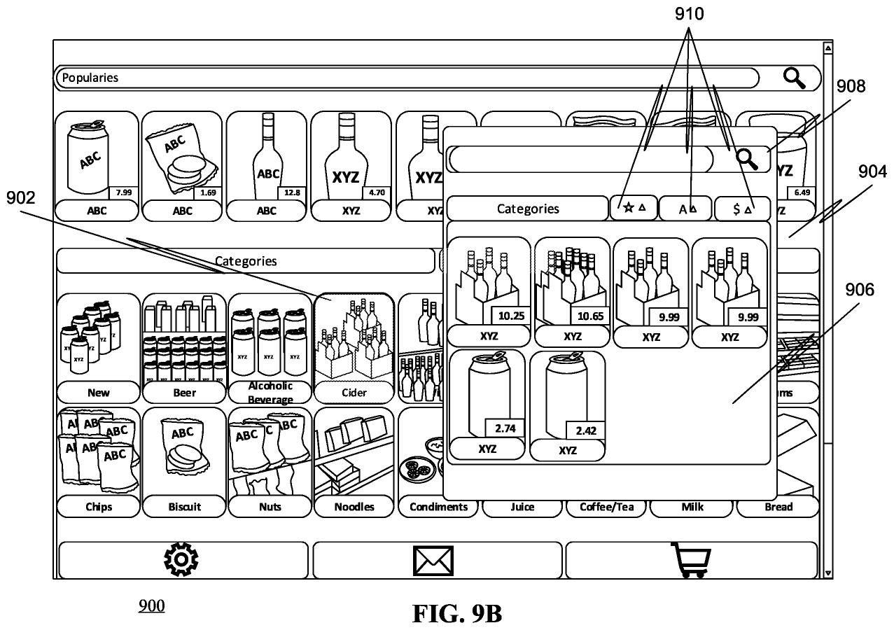

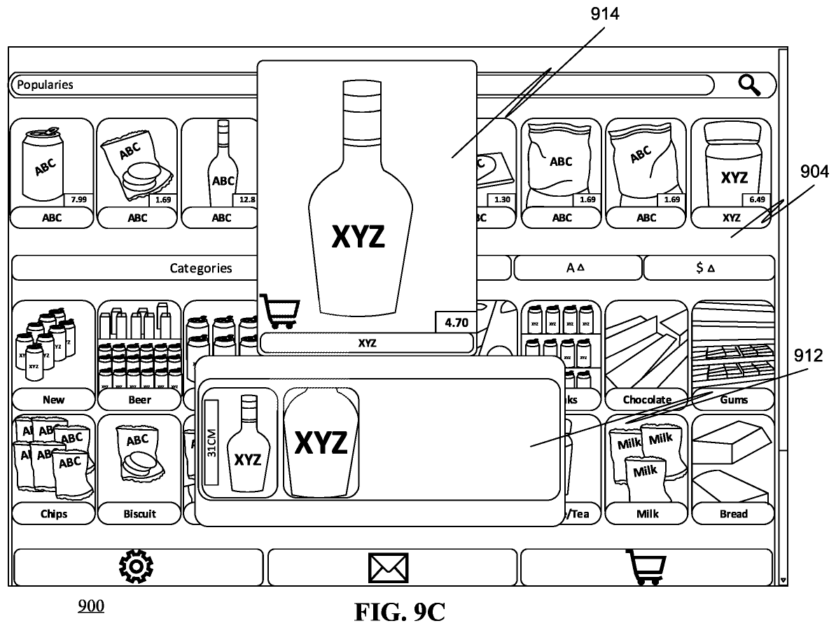

FIGS. 9A, 9B, and 9C show an exemplary shopping interface 900 that displays multiple products with names in rows and columns. Accordingly, as block 902 is clicked, the block 902 may leave an original position and partially cover neighboring blocks to show a pop-up effect.

Accordingly, if the block 902 corresponds to a category of products, a new panel 906 may open to show one or more products and/or sub-categories included in the category represented by the block 902. Further, the new panel 906 may be displayed at a same level with the block 902. The new panel 906 may also include a search button 908, and sort buttons 910.

Further, other blocks surrounding block 902 may be covered in a color, such as grey to make the pop-up effect more evident. Thus, the block 902 may open a top layer against the other blocks, which may comprise a bottom layer 904.

Further, if the block 902 corresponds to an individual product, the product may be displayed in a panel 912 on top of the layer 904. Further, if a thumbnail image of the panel 912 is clicked or touched, a magnified image 914 may be displayed.

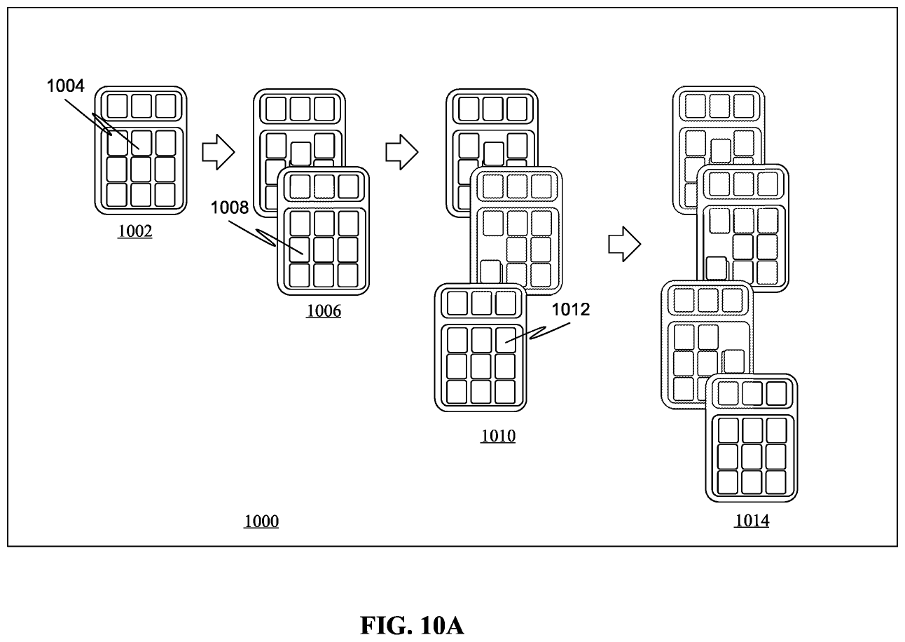

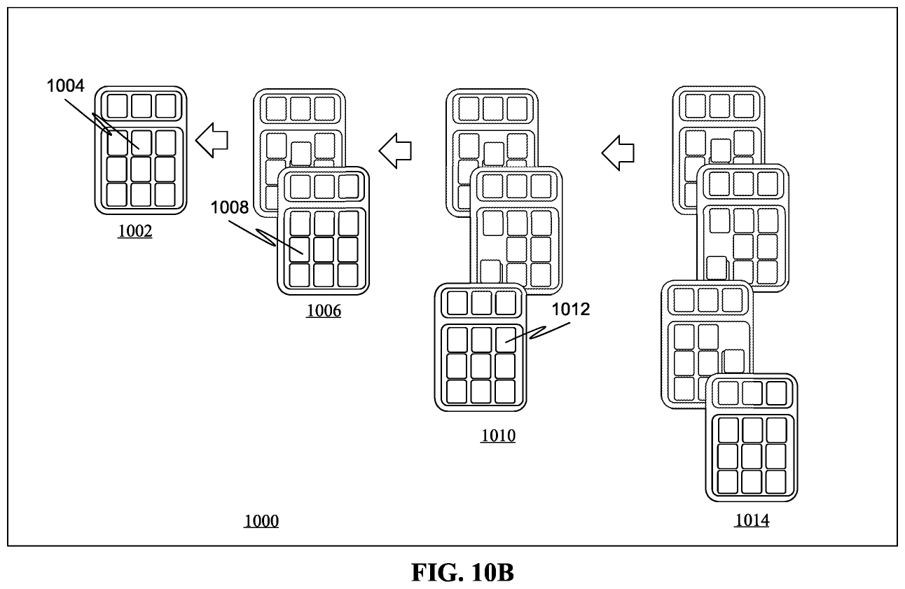

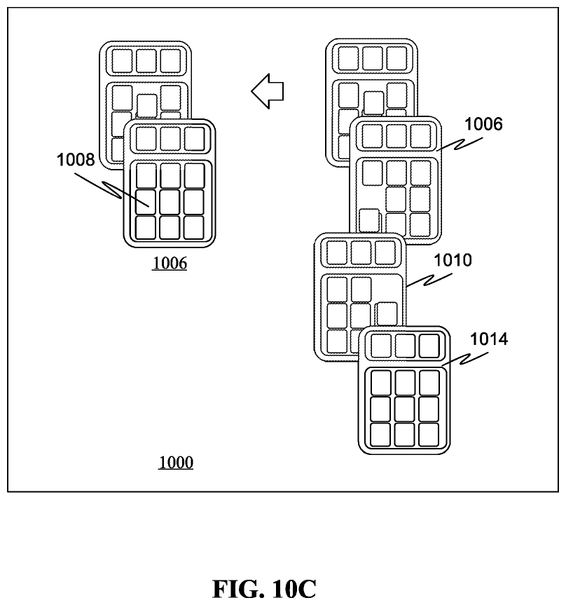

FIGS. 10A, 10B, and 10C illustrate a mechanism to display additional overlapping panels in the shopping interface, in accordance with some embodiments. Accordingly, as shown in FIG. 10 A, if a block 1004 in the panel 1002 is clicked to display a sub-category, a new panel 1006 may emerge that may cover most of the panel 1002. However, block 1004 may be left uncovered and may be included in the panel 1006. Further, as shown, additional panels 1010, and 1014 may open based on interaction with blocks 1008, and 1012. Accordingly, the multiple panels (1002, 1006, 1010, and 1014) may open as a chain and may be partially overlapping to confine a topmost panel.

Further, as shown in FIG. 10 B, the chain may be successively canceled by clicking on a previous panel (shown in grey), leading to the clicked panel of the chain to be successively restored as the topmost panel.

Further, as shown in FIG. 10 C, the chain may be canceled and restored to any previous panel by on any previous panel (shown in grey), leading to the clicked panel of the chain to be successively restored as the topmost panel. Accordingly, as shown in FIG. 10 C, clicking on the grey panel 1006 may restore the panel 1006 as the topmost panel.

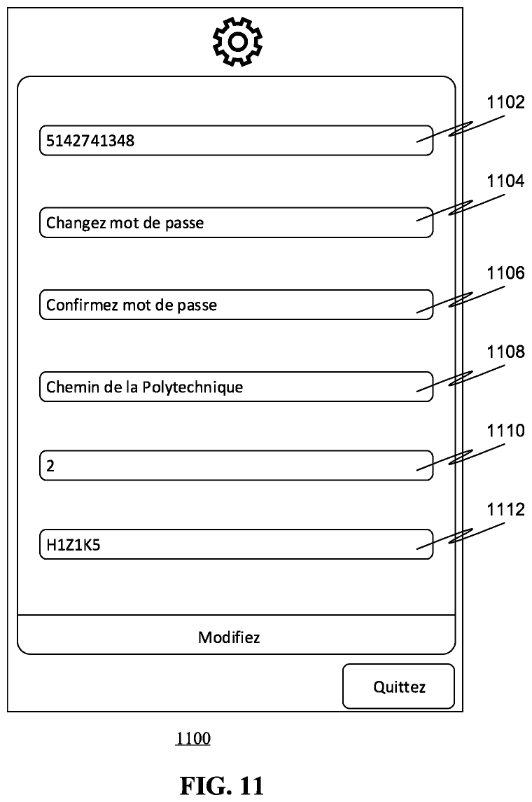

Further, as shown in FIG. 11, a setting panel 1100 may be located at the bottom of the shopping interface 700. The setting panel may include multiple input areas such as the areas 1102, 1104, 1106, 1108, 1110, and 1112 to modify personal information such as phone number, address, postcode, and so on.

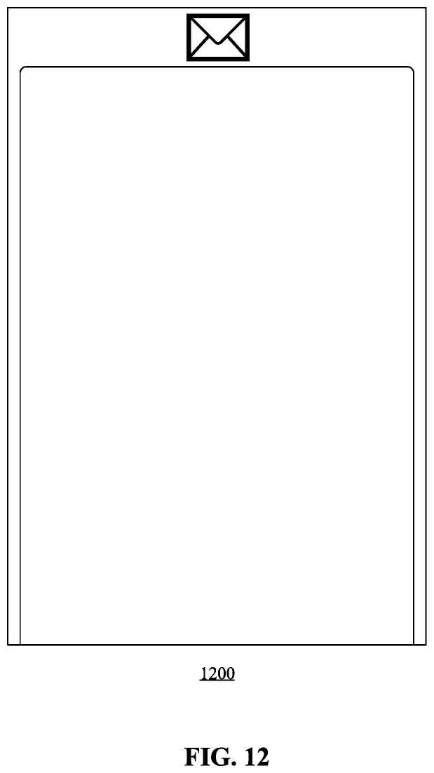

Further, as shown in FIG. 12, a message panel 1200 may be located at the bottom of the shopping interface 700, such as besides the setting panel 1100. The message panel 1200 may allow a user to communicate with remote servers and/or other administrators of the shopping interface 700.

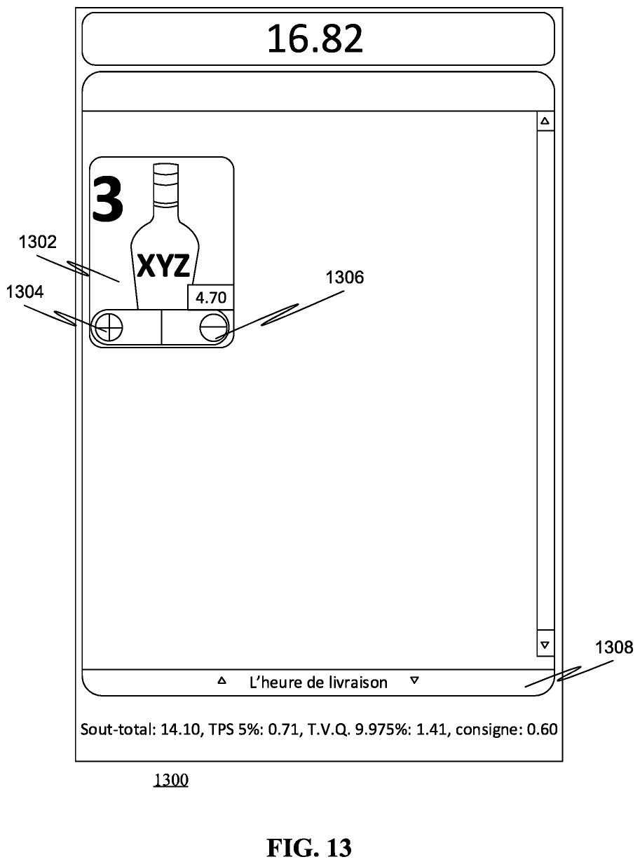

Further, as shown in FIG. 13, a shopping cart 1300 may be located on the shopping interface 700. Accordingly, the shopping cart 1300 may include one or more ordered products, such as a product 1302. A user may readjust quantities of the product 1302 by clicking on a plus button 1304, or a minus button 1306. Further, a button 1308 may allow the user to choose a desired delivery time.

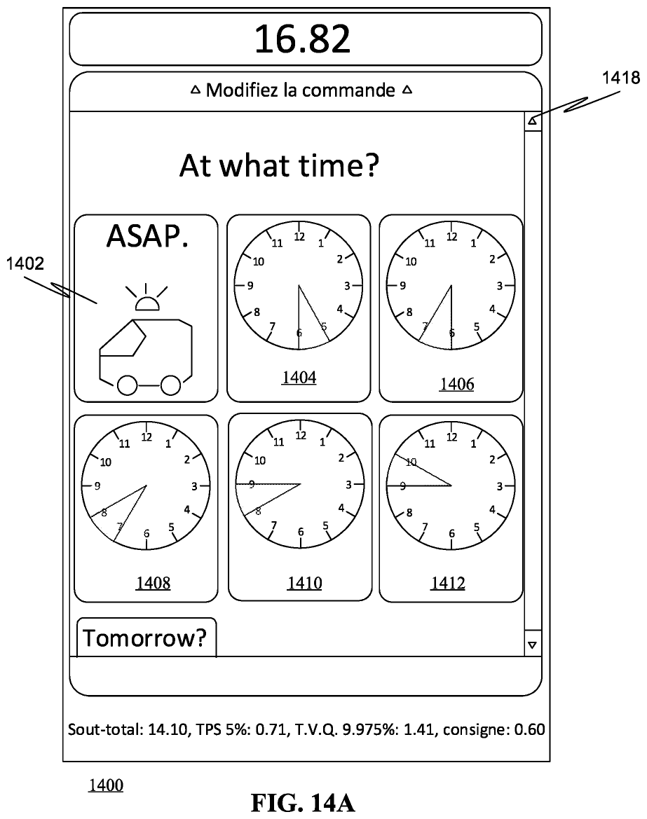

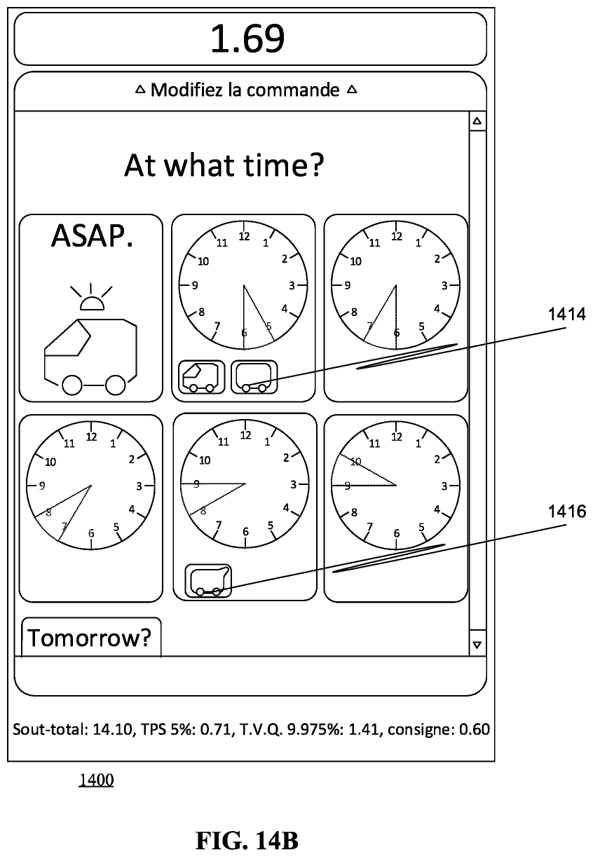

Further, as shown in FIGS. 14A and 14B, a choose hour section 1400 may allow the user to choose a desired delivery time. An emergency order button 1402 may enable the user to make the order most prioritized, followed by buttons 1404, 1406, 1408, 1410, and 1412 displaying available delivery times. Further, a button 1418 may allow a user to review the order. Further, as shown in FIG. 14B, icons 1414 and 1416 may be displayed to indicate scheduled orders in different time sections. By selecting the desired time, the current order may be added to a certain time. Accordingly, the ordered product may be delivered to the user.

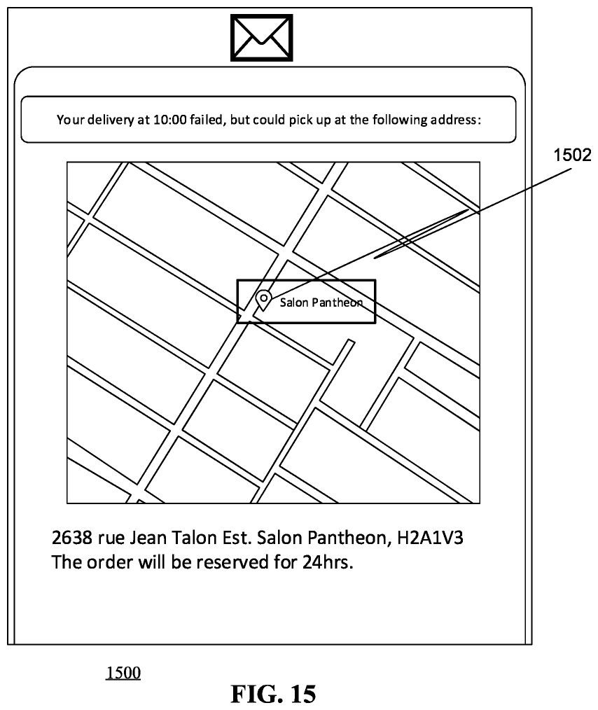

Further, as shown in FIG. 15, a failed delivery section 1500 may allow the user to view a current location 1502 of the one or more ordered products. Accordingly, the user may be able to pick up the one or more ordered products from the current location 1502.

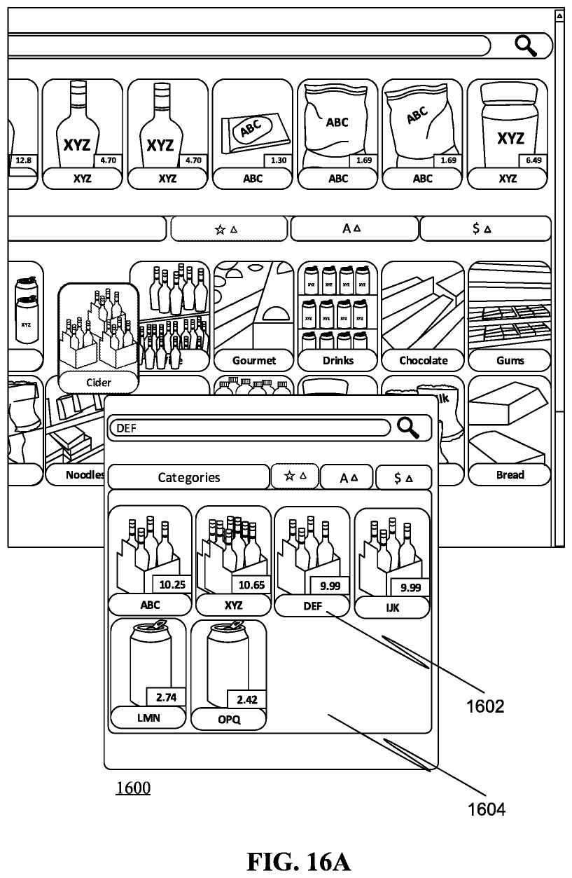

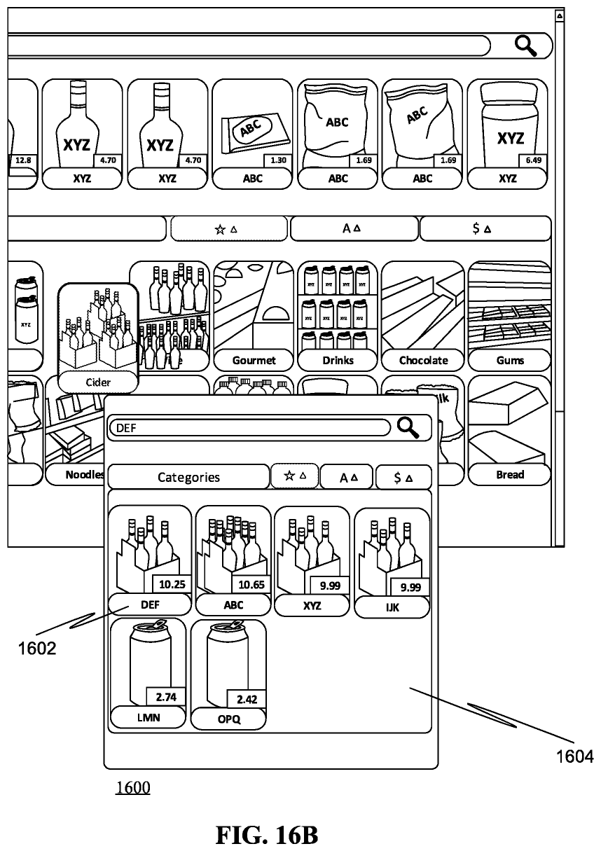

Further, in an embodiment, the shopping interface may include a machine learning aspect. For instance, when a user searches in a search bar, a search history may be recorded. Accordingly, the content panel corresponding to the search history may be rearranged according to the search history. For example, as shown in FIGS. 16A and 16B, a user may search for a product 1602 in an exemplary panel 1604 of an exemplary shopping interface 1600. Accordingly, the search history may be preserved, and the panel 1604 may be rearranged to display product 1602 first. Further, the panel 1604 may be rearranged based on search history, view history, purchase history, and so on.

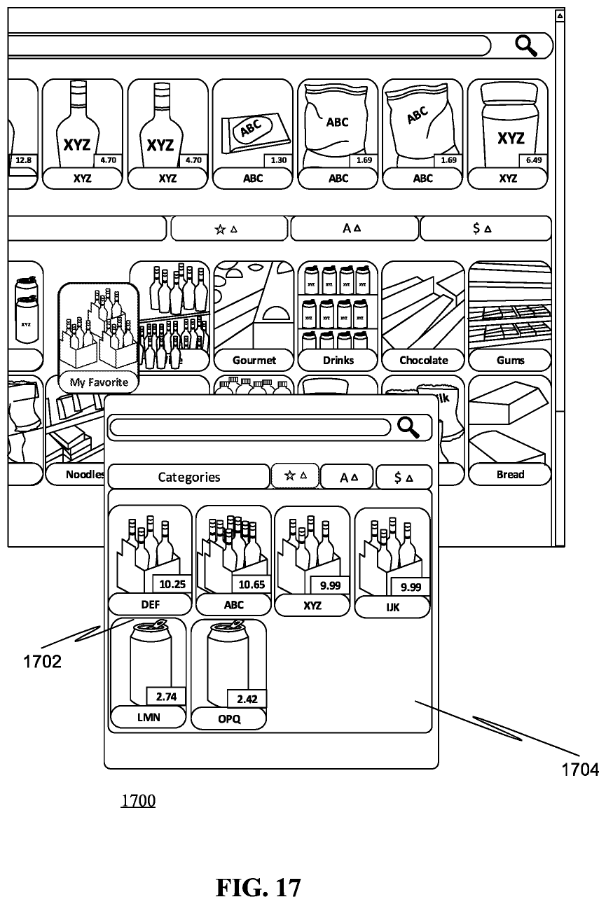

Further, based on factors such as search history, view history, purchase history, and so on, a “My favorite” category may be created in the shopping interface. Accordingly, as shown in FIG. 17, the exemplary shopping interface 1700 may include one or more “My favorite” cards, such as the “My favorite” card 1702 in the panel 1704. The one or more “My favorite” cards may represent the customized “My favorite” category.

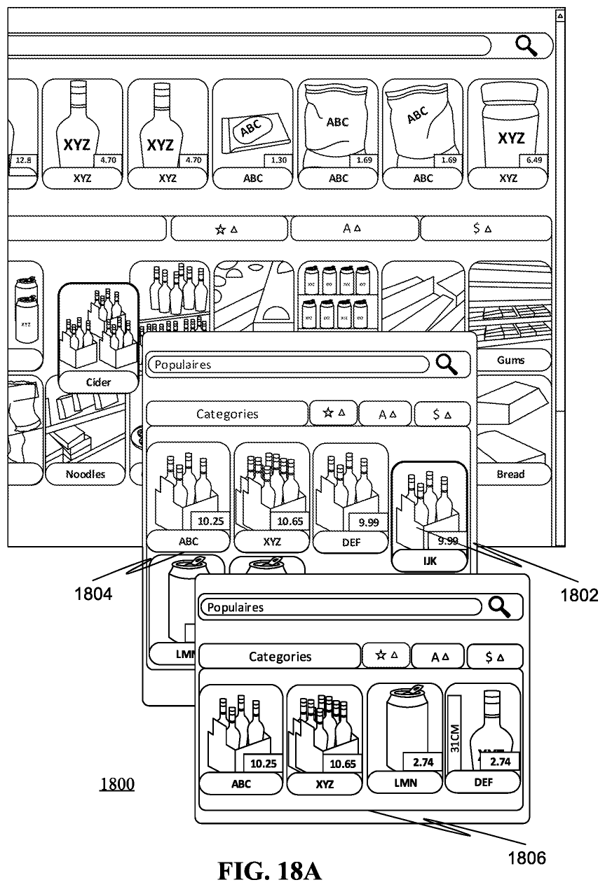

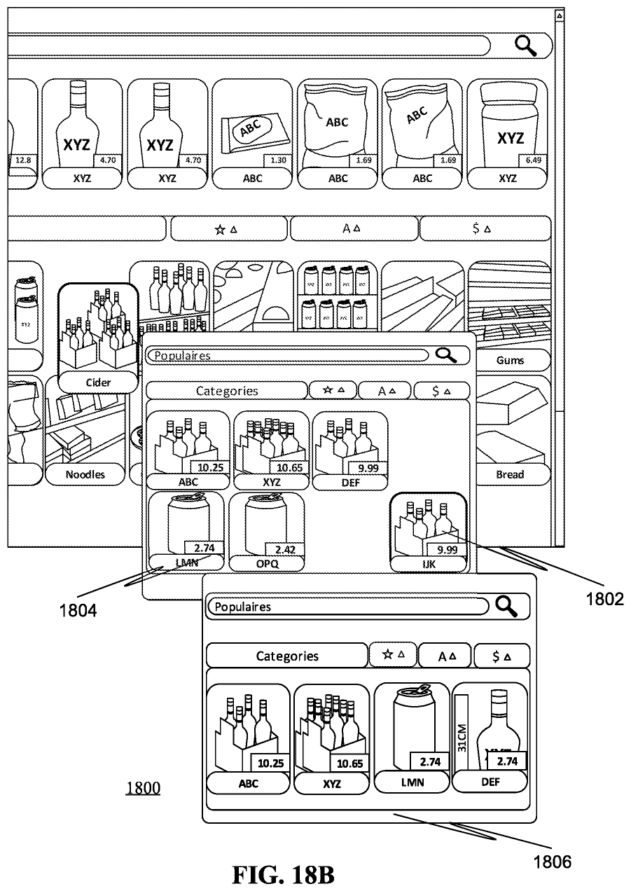

Further, in an embodiment, when a new panel of the shopping interface appears, a corresponding old panel may shrink in length so as to still display products in the panel. For instance, as shown in FIGS. 18A and 18B, when the product 1802 in the panel 1804 is clicked, a new panel 1806 may appear. Accordingly, the panel 1804 may shrink in length (as shown in FIG. 18B) so as to still products in the panel 1804. After the operation, if the panel 1804 is clicked, the panel 1806 may disappear and the panel 1804 may recover to an original size.

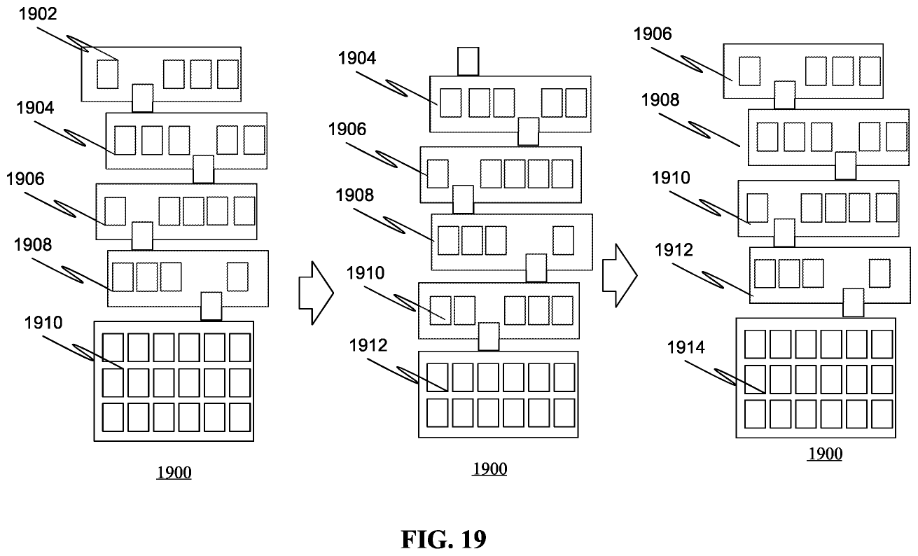

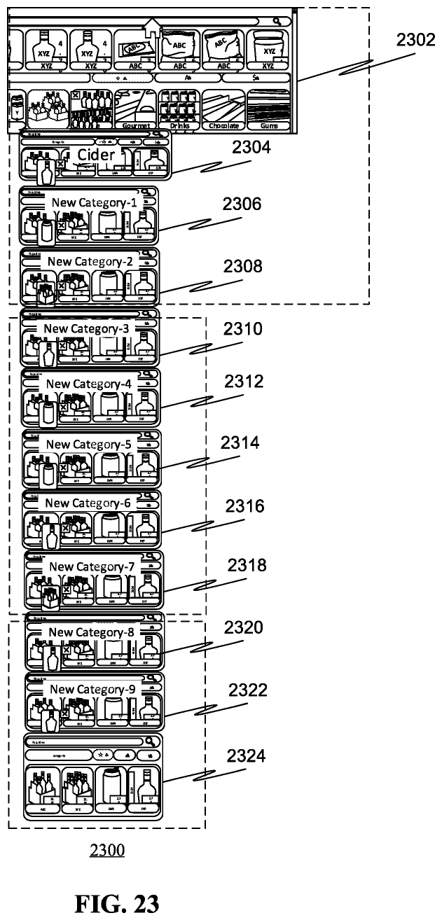

Further, in an embodiment, the maximum number of panels of a shopping interface displayed simultaneously may be limited. Accordingly, as shown in FIG. 19, an exemplary shopping interface 1900 may include multiple panels, and panels 1902, 1904, 1906, 1908, and 1910 may be open and may be displayed on the display of a user device. Further, as one or more new panels are opened, the one or more uppermost panels may be removed from the display so as to conserve display space. Accordingly, as new panels 1912 and 1914 are subsequently opened, uppermost panels 1902 and 1904 may be removed from the display. Further, the number of simultaneously displayed panels may vary by factors such as device performance (processor and RAM), display configuration (display size, resolution), and so on. For instance, as shown in FIG. 23, the exemplary shopping interface 2300 may include 12 panels (2302, 2304, 2306, 2308, 2310, 2312, 2314, 2316, 2318, 2320, 2322, and 2324). Out of these, only 5 panels may be visible at a time. For instance, panels 2310, 2312, 2314, 2316, and 2318 may be visible. Further, upon scrolling up or down, subsequent upper panels 2302, 2304, 2306, and 2308, or subsequent lower panels 2320, 2322, and 2324 may be visible.

Further, in an instance, the shopping interface may be manipulated by sensory input from a user device, such as shaking of a smartphone. The shaking of the smartphone may be recognized through sensory input, as received from sensors such as gyroscope and accelerometer, and may be configured to interact and manipulate the shopping interface, such as removing of panels.

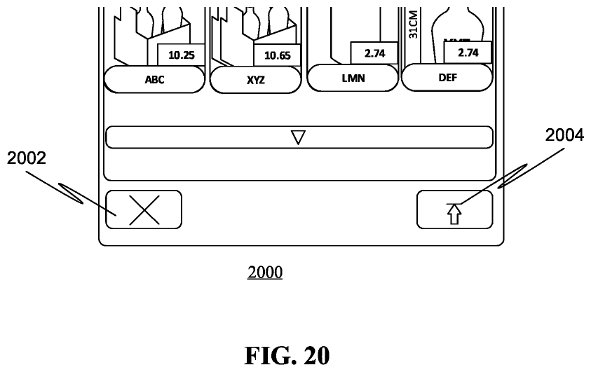

Further, in an embodiment, as shown in FIG. 20, the shopping interface, such as the exemplary shopping interface 2000 may include a delete button and a go-top button. The delete button 2002 may delete a current panel and restore a previous panel. Further, the go-top button 2004 may directly scroll to the top of the shopping interface, to allow a user to interact with any panel.

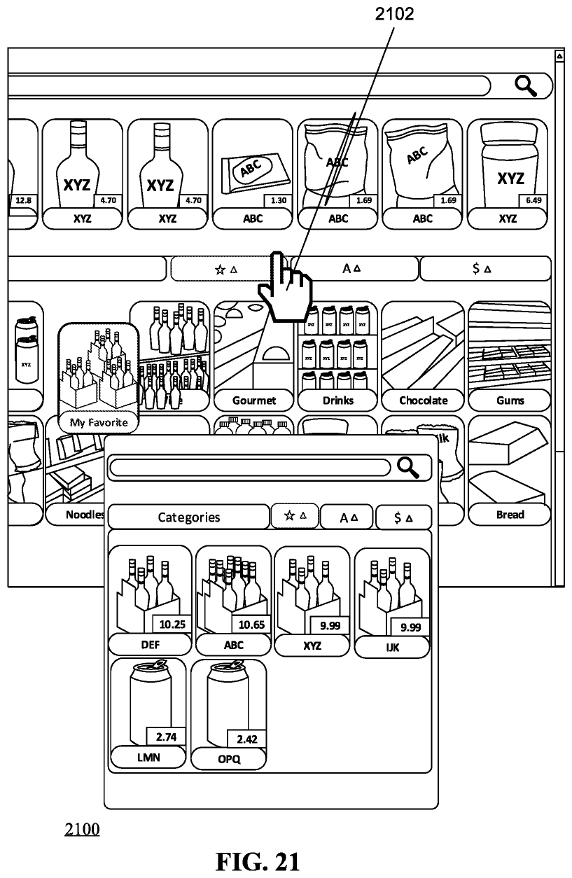

Further, in an embodiment, as shown in FIG. 21, the shopping interface, such as the exemplary shopping interface 2100 may include a touch symbol 2102 to encourage new users to touch or click an area as a tutorial exercise.

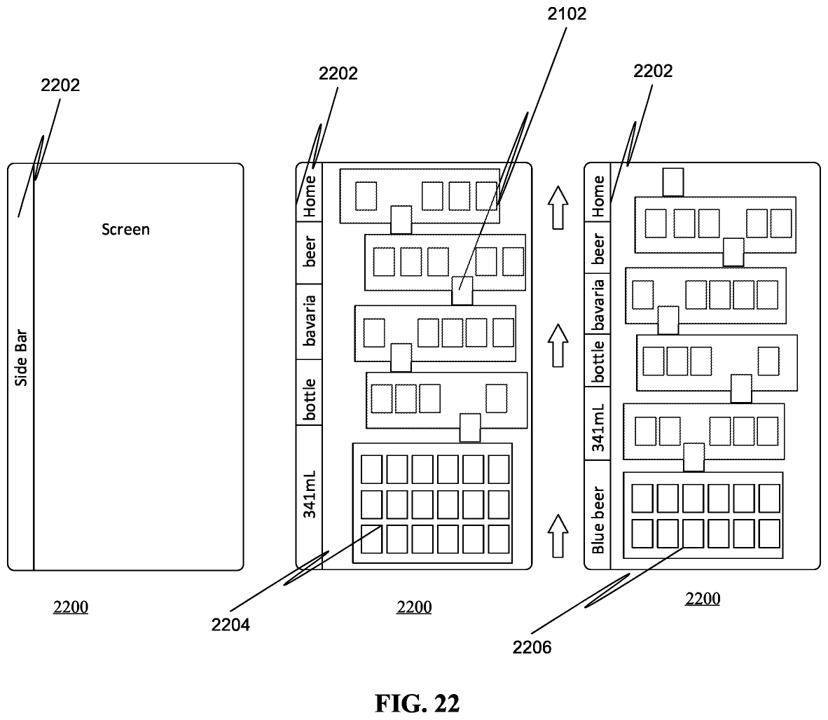

Further, in an embodiment, as shown in FIG. 22, the shopping interface, such as the exemplary shopping interface 2200 may include a side bar 2202 displaying a current panel amongst multiple open panels. Every time when a new panel is opened, such as the panels 2204 and 2206, or while scrolling up or down, the side bar 2202 may be displayed to display a current progress in panels.

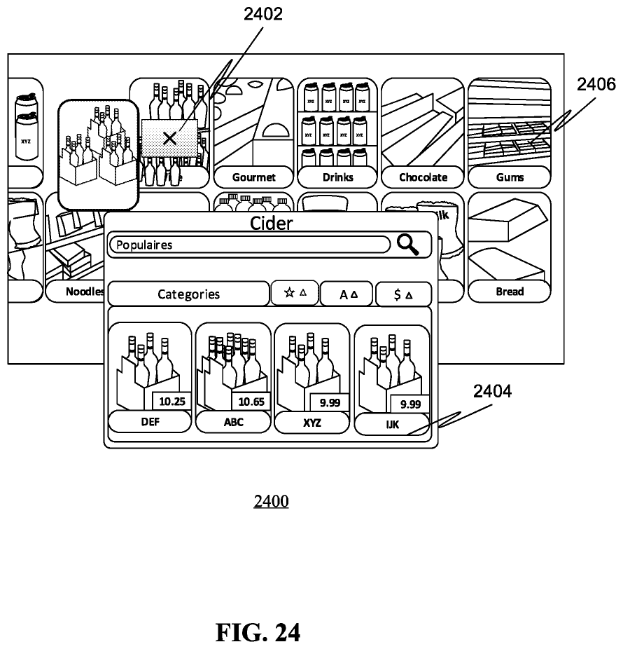

Further, in an embodiment, as shown in FIG. 24, the shopping interface, such as the exemplary shopping interface 2400 may include a close, (or “delete”) button 2402 beside active panel. The close button 2402 may close the corresponding panel 2404, and the panel 2406 corresponding to a higher level of hierarchy may be turned active.

Further, in an embodiment, the shopping interface, such as the exemplary shopping interface 2500 may include one or more symbols (such as icons and/or text) depicting a clicked sequence of panels and describing the one or more clicked panels. For instance, the shopping interface 2500 shows symbols 2502, 2506, and 2510, corresponding to clicked panels 2504, 2508, and 2512 respectively, describing the one or more clicked panels.

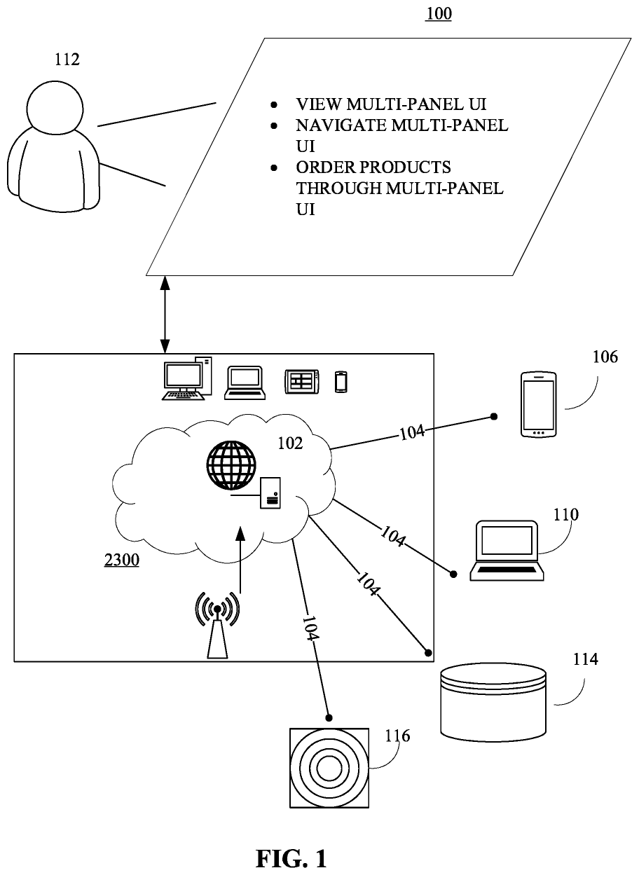

FIG. 1 is an illustration of an online platform 100 consistent with various embodiments of the present disclosure. By way of non-limiting example, the online platform 100 to generate a multi-panel UI based on hierarchy data corresponding to digital content may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116, over a communication network 104, such as, but not limited to, the Internet. Further, users of the online platform 100 may include relevant parties such as, but not limited to, end users, e-commerce platforms, administrators. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2700.

According to some embodiments, the online platform 100 may be configured to generate a multi-panel UI based on hierarchy data corresponding to digital content.

Further, according to some embodiments, a system, such as the system 2700, to facilitate generation of a multi-panel UI based on a hierarchy data corresponding to a digital content is also disclosed. The system may include a communication device, such as input device(s) 2712, output device(s) 2714, and communication connections 2716 configured for receiving the hierarchy data corresponding to the digital content from a computing device. Further, the communication device may be configured for transmitting the multi-panel UI to a user device. Further, the user device may be configured to render the multi-panel UI.

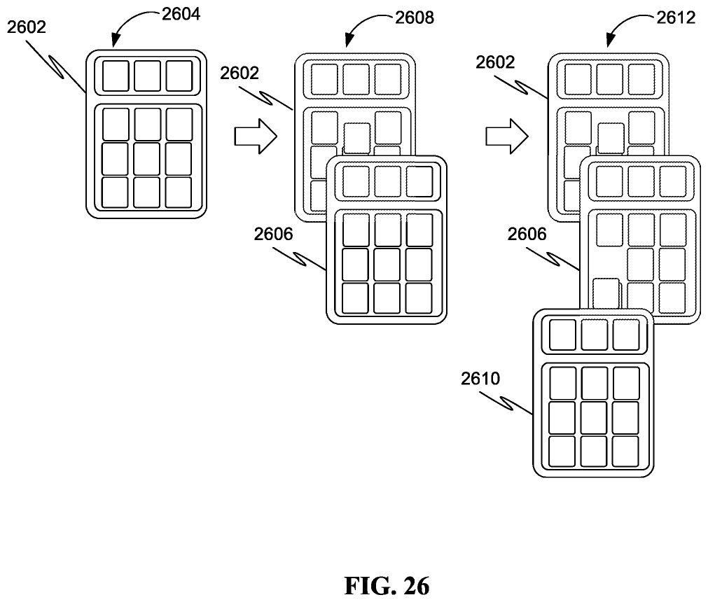

Further, the system may include a processing device, such as processing unit 2710 configured for generating the multi-panel UI based on the hierarchy data. Further, the multi-panel UI may include a plurality of panels corresponding to a plurality of levels of hierarchy. Further, each panel of the plurality of panels may include a visual representation of a plurality of categories associated with a corresponding level of hierarchy. Further, the multi-panel UI may include a first panel corresponding to a first level of hierarchy and a second panel corresponding to a second level of hierarchy, such as the first panel 2602, and the second panel 2606 illustrated in FIG. 26. Further, the first level of hierarchy may be higher than the second level of hierarchy. Further, the multi-panel UI may be configured for displaying a first form of the first panel 2606 (as shown in view 2604) based on a first panel selection input corresponding to the first panel. The first panel selection input may be received as an explicit input, such as a selection of a category in a level of hierarchy, or an implicit input such as login to a home page or hovering of a mouse on taxonomy may display the first panel corresponding to the first level of the hierarchy.

Further, the multi-panel UI may be configured for displaying a first form of the second panel 2606 based on a second panel selection input corresponding to the second panel 2606. For e.g. the second panel selection input may correspond to a category (or item) comprised in the first panel. Further, a second form of the first panel may be configured to be displayed concurrently with the displaying of the second panel 2606 (as shown in view 2608).

Further, the multi-panel UI may be configured for displaying the first form of the first panel based on a first panel re-selection input corresponding to the first panel 2602. Further, the displaying of the first form of the second panel 2606 may be terminated based on the first panel re-selection input. In some embodiments, the first panel re-selection input may be received in relation to the first panel 2602. For example, a touch input on the at least one portion of the first panel 2602 that continues to be displayed may constitute the first panel re-selection input. In another embodiment, the first panel re-selection input may be received in relation to the second panel 2606. For example, the second panel 2606 may include a delete button. Accordingly, a touch input received on the delete button may constitute the first panel re-selection input. Likewise, in another embodiment, the first panel re-selection input may be received on a GUI element (e.g. scroll bar) displayed separately from each of the first panel 2602 and the second panel 2606.

In some embodiments, the second form of the first panel 2602 may include at least a portion of the first panel 2602. Further, at least one first visual characteristic associated with the at least one portion may be dynamically modified to be distinct from at least one second visual characteristic associated with the first form of the second panel 2606. In an instance, the dynamic modification may be gradual, and may include an animated transitioning effect such as shrinking, expanding, gradually fading, and so on. For example, the at least one portion of the first panel 2602 may be “grayed out” (faded) in comparison with the first form of the second panel 2606.

In some embodiments, at least one first visual characteristic associated with the first form of the first panel 2602 may be dynamically modified to be distinct from at least one second visual characteristic associated with the second form of the first panel 2602.

In some embodiments, the multi-panel UI further may include a third panel corresponding to a third level of hierarchy, such as the third panel 2610 as shown in FIG. 26. Further, the second level of hierarchy may be higher than the third level of hierarchy. Further, the multi-panel UI may be further configured for displaying a first form of the third panel 2610 based on a third panel selection input corresponding to the third panel 2610. Further, each of the second form of the first panel 2602 and a second form of the second panel 2606 may be configured to be displayed concurrently with the displaying of the first form of the third panel 2610 (as shown in view 2612).

Further, the multi-panel UI may be further configured for displaying and displaying the first form of the first panel 2602 based on the first panel re-selection input corresponding to the first panel 2602. Further, the displaying of each of the first form of the second panel 2606 and the first form of the third panel 2610 may be terminated based on the first panel re-selection input.

In some embodiments, the second form of the first panel 2602 may include an invisible form of the first panel 2602. Further, the displaying of the second form of the first panel 2602 may be further based on detection of a condition. In general, the condition may include any situation where it may be preferable to make the first panel 2602 disappear from the display. For example, the first panel 2602 and the second panel 2606 may be separated by a plurality of intermediate panels corresponding to intermediate levels of hierarchy between the first level of hierarchy and the second level of hierarchy. For example, assume in an instance, that based on the display size of the user device and the multi-panel UI, a total number of 5 panels may be comfortably viewed and navigated across by a user of the user device. Further, assume that the number of intermediate panels to be 4 in number. Accordingly, when the second panel selection input is received causing the second panel 2606 to be displayed, the first panel 2602 may be made invisible maintaining the total number of actively displayed panels at 5.

In some embodiments, each of the first form of the first panel 2602 and the first form of the second panel 2606 may include one or more of a search interface configured to receive a search query, a sorting interface configured to sort a plurality of categories associated with a corresponding panel, and a virtual shopping cart interface.

In some embodiments, the multi-panel UI further may include a side bar configured to visually represent the plurality of levels of hierarchy based on one or more of the first panel selection input, the second panel selection input and the first panel re-selection input.

Further, the system may include a storage device, such as removable storage 2709, and non-removable storage 2710, configured for storing the multi-panel UI.

In some embodiments, the communication device may be further configured for receiving at least one device characteristic associated with the user device. Further, the generating of the multi-panel UI may be further based on the at least one device characteristic. In some embodiments, the at least one device characteristic may include a display size associated with the user device. Further, one or more of a number and a panel size associated with the plurality of panels of the multi-panel UI may be based on the display size.

In some embodiments, the third panel selection input may be based on a sensor data associated with at least one sensor comprised in the user device. In some embodiments, the at least one sensor may include a touchscreen. Accordingly, the third panel selection input may include a touch action. In some embodiments, the at least one sensor may include a motion sensor (e.g. accelerometer). Accordingly, in an instance, a user of the user device may impart a motion (e.g. shaking motion) on the user device. As a result, the sensor data representing the motion may constitute the third panel selection input. As a result, upon imparting the motion, the first panel 2602 may be displayed completely while the displaying of the second panel 2606 may be terminated.

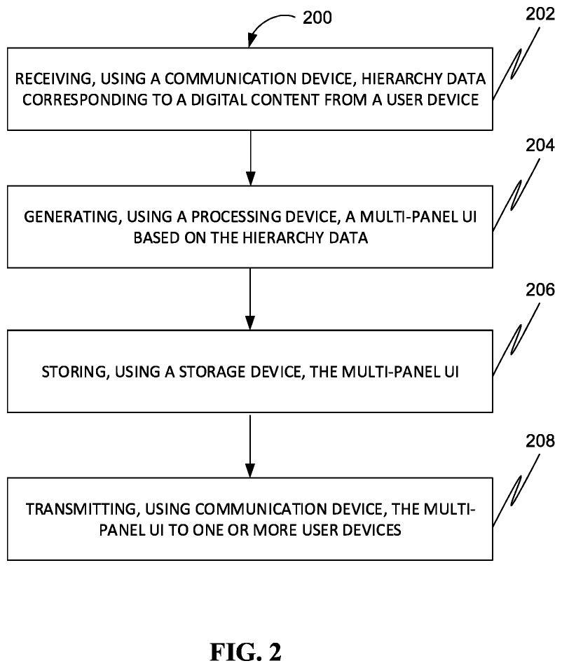

FIG. 2 shows a flowchart 200 of a method to facilitate generation of a multi-panel UI based on a hierarchy data corresponding to a digital content, in accordance with some embodiments.

Accordingly, at 202, the method may include receiving, using a communication device, the hierarchy data corresponding to the digital content from a computing device. Digital content may include images, videos, and/or text. In an exemplary embodiment, digital content may include images, videos, and/or text providing details about one or more products, such as products that may be available for purchase on an e-commerce platform, wherein the one or more products may correspond to one or more product categories and subcategories. A category of the one or more categories may represent a general collection of one or more products, which may be determined as having particular shared characteristics. Further, a category may include one or more subcategories, each of which may constitute a more specific division of type of products of the category. For instance, the one or more categories may include electronics and appliances, fitness and sports products, computers, and so on, each with subcategories such as home appliances and kitchen appliances, cardio equipment and running equipment, and laptops and desktops respectively. Accordingly, the hierarchy data may include an indication of the categorization and subcategorization of the products. Further, a level of the one or more categories, subcategories, products, and so on may be indicated in the hierarchy data. For instance, all product categories may be at an uppermost level and may be followed by one or more subcategories, all of which may be said to be at a second level. The first level of hierarchy may be higher than the second level of hierarchy. Further, the hierarchy data may include an indication of one or subcategories, sub-subcategories, products, and so on included in each category. For instance, the category of books may include the sub-categories of academic and non-academic books. Academic books may include further sub-subcategories representing a field of academia, and so on. Oppositely, non-academic books may include sub-subcategories of fiction and nonfiction, which may be further sub-sub-subcategorized, and so on. In an instance, the hierarchy data may be received through a user device, such as a server computer, used to host the hierarchy data. For instance, the server computer may host hierarchy data corresponding to an e-commerce platform, such as Amazon®.

Further, at 204, the method may include generating, using a processing device, the multi-panel UI based on the hierarchy data. Further, the multi-panel UI may include a plurality of panels corresponding to a plurality of levels of hierarchy. Further, each panel of the plurality of panels may include a visual representation of a plurality of categories associated with a corresponding level of hierarchy. Further, the multi-panel UI may include a first panel corresponding to a first level of hierarchy and a second panel corresponding to a second level of hierarchy, such as the first panel 2602, and the second panel 2606 illustrated in FIG. 26. Further, the first level of hierarchy may be higher than the second level of hierarchy. Further, the multi-panel UI may be configured for displaying a first form of the first panel 2606 (as shown in view 2604) based on a first panel selection input corresponding to the first panel. The first panel selection input may be received as an explicit input, such as a selection of a category in a level of hierarchy, or an implicit input such as login to a home page or hovering of a mouse on taxonomy may display the first panel corresponding to the first level of the hierarchy.

Further, the multi-panel UI may be configured for displaying a first form of the second panel 2606 based on a second panel selection input corresponding to the second panel 2606. For e.g. the second panel selection input may correspond to a category (or item) comprised in the first panel. Further, a second form of the first panel may be configured to be displayed concurrently with the displaying of the second panel 2606 (as shown in view 2608).

Further, the multi-panel UI may be configured for displaying the first form of the first panel based on a first panel re-selection input corresponding to the first panel 2602. Further, the displaying of the first form of the second panel 2606 may be terminated based on the first panel re-selection input. In some embodiments, the first panel re-selection input may be received in relation to the first panel 2602. For example, a touch input on the at least one portion of the first panel 2602 that continues to be displayed may constitute the first panel re-selection input. In another embodiment, the first panel re-selection input may be received in relation to the second panel 2606. For example, the second panel 2606 may include a delete button. Accordingly, a touch input received on the delete button may constitute the first panel re-selection input. Likewise, in another embodiment, the first panel re-selection input may be received on a GUI element (e.g. scroll bar) displayed separately from each of the first panel 2602 and the second panel 2606.

In some embodiments, the second form of the first panel 2602 may include at least a portion of the first panel 2602. Further, at least one first visual characteristic associated with the at least one portion may be dynamically modified to be distinct from at least one second visual characteristic associated with the first form of the second panel 2606. In an instance, the dynamic modification may be gradual, and may include an animated transitioning effect such as shrinking, expanding, gradually fading, and so on. For example, the at least one portion of the first panel 2602 may be “grayed out” (faded) in comparison with the first form of the second panel 2606.

In some embodiments, at least one first visual characteristic associated with the first form of the first panel 2602 may be dynamically modified to be distinct from at least one second visual characteristic associated with the second form of the first panel 2602.

In some embodiments, the multi-panel UI further may include a third panel corresponding to a third level of hierarchy, such as the third panel 2610 as shown in FIG. 26. Further, the second level of hierarchy may be higher than the third level of hierarchy. Further, the multi-panel UI may be further configured for displaying a first form of the third panel 2610 based on a third panel selection input corresponding to the third panel 2610. Further, each of the second form of the first panel 2602 and a second form of the second panel 2606 may be configured to be displayed concurrently with the displaying of the first form of the third panel 2610 (as shown in view 2612).

Further, the multi-panel UI may be further configured for displaying and displaying the first form of the first panel 2602 based on the first panel re-selection input corresponding to the first panel 2602. Further, the displaying of each of the first form of the second panel 2606 and the first form of the third panel 2610 may be terminated based on the first panel re-selection input.

In some embodiments, the second form of the first panel 2602 may include an invisible form of the first panel 2602. Further, the displaying of the second form of the first panel 2602 may be further based on detection of a condition. In general, the condition may include any situation where it may be preferable to make the first panel 2602 disappear from the display. For example, the first panel 2602 and the second panel 2606 may be separated by a plurality of intermediate panels corresponding to intermediate levels of hierarchy between the first level of hierarchy and the second level of hierarchy. For example, assume in an instance, that based on the display size of the user device and the multi-panel UI, a total number of 5 panels may be comfortably viewed and navigated across by a user of the user device. Further, assume that the number of intermediate panels to be 4 in number. Accordingly, when the second panel selection input is received causing the second panel 2606 to be displayed, the first panel 2602 may be made invisible maintaining the total number of actively displayed panels at 5.

In some embodiments, each of the first form of the first panel 2602 and the first form of the second panel 2606 may include one or more of a search interface configured to receive a search query, a sorting interface configured to sort a plurality of categories associated with a corresponding panel, and a virtual shopping cart interface.

In some embodiments, the multi-panel UI further may include a side bar configured to visually represent the plurality of levels of hierarchy based on one or more of the first panel selection input, the second panel selection input and the first panel re-selection input.

In an exemplary embodiment, the multi-panel UI may include a plurality of panels corresponding to the plurality of levels of the hierarchy. Each panel in the plurality of panels may comprise a visual depiction of a plurality of categories associated with a corresponding level of the hierarchy. Accordingly, the first level of hierarchy, comprising the plurality of categories may be depicted in a first panel 2602 through a plurality of blocks containing images and corresponding textual information. Further, interaction (such as through a click) with a block in the first panel 2602 in the multi-panel UI may lead to the revelation of a second panel 2606 of the multi-panel UI. The second panel 2606 may comprise a visual depiction of a plurality of sub-categories of the first category, which may be associated with a second level of the hierarchy. Further, upon revelation, the second panel 2606 may act as an active panel, and the first panel 2602 may act as an inactive panel. An active panel may be described as a panel that may, upon interaction with one or more blocks comprising the panel, may lead to the revelation of an additional panel corresponding to a lower level of the hierarchy. Conversely, interaction with an inactive panel corresponding to a higher level of hierarchy may lead to a progressive disappearance of one or more active and inactive panels (lower in hierarchy to the interacted panel), until the panel that may have been interacted with may be active. Accordingly, further panels of the multi-panel UI, each corresponding to a lower level of the hierarchy, may be revealed on interaction with an active panel, and one or more active and inactive panels (each corresponding to a subsequent higher level of hierarchy) may disappear on interaction with an inactive panel until the inactive panel is active.

Further, at 206, the method may include storing, using a storage device, the multi-panel UI.

Further, at 208, the method may include transmitting, using the communication device, the multi-panel UI to a user device. Further, the user device may be configured to render the multi-panel UI. In an instance, user device may include an electronic device such as, for example, a desktop computer, a laptop computer, a tablet computer, and mobile device such as a smartphone operated by an end user. Further, in an instance, the user device may a include device that may host the hierarchy data and the generated multi-panel UI, such as a server computer.

In some embodiments, the method may further include receiving, using the communication device, at least one device characteristic associated with the user device. Further, the generating of the multi-panel UI may be further based on the at least one device characteristic. In general, the at least one device characteristic may include one or more of a hardware characteristics (memory characteristics, processor characteristics, display device characteristics etc.), a software characteristic (operating system, apps etc.) and a network characteristic (network bandwidth etc.). In some embodiments, the at least one device characteristic may include a display size associated with the user device. Further, one or more of a number and a panel size associated with the plurality of panels of the multi-panel UI may be based on the display size.

Accordingly, in some embodiments, the hierarchy data may be transformed to correspond with the number. In other words, at least some of the levels of hierarchy may be merged.

In some embodiments, the third panel selection input may be based on a sensor data associated with at least one sensor comprised in the user device. In some embodiments, the at least one sensor may include a touchscreen. Accordingly, the third panel selection input may include a touch action. In some embodiments, the at least one sensor may include a motion sensor (e.g. accelerometer). Accordingly, in an instance, a user of the user device may impart a motion (e.g. shaking motion) on the user device. As a result, the sensor data representing the motion may constitute the third panel selection input. As a result, upon imparting the motion, the first panel 2602 may be displayed completely while the displaying of the second panel 2606 may be terminated.

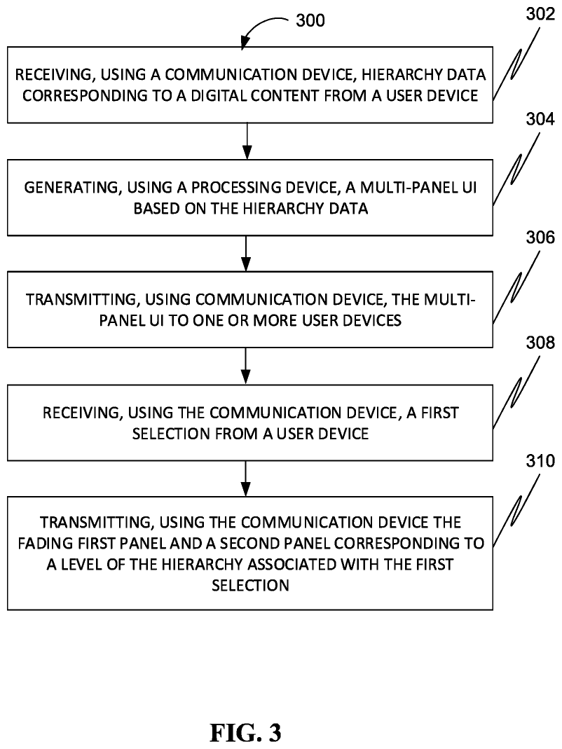

FIG. 3 shows a flowchart 300 of a method to generate a multi-panel UI based on hierarchy data corresponding to digital content, in accordance with some embodiments. Accordingly, at 302, the method may include receiving, using a communication device, hierarchy data corresponding to a digital content from a user device. Digital content may include details about one or more products, which may be available for purchase on an e-commerce platform, wherein the one or more products may correspond to one or more product categories and subcategories. A category of the one or more categories may represent a general collection of one or more products, which may be determined as having particular shared characteristics. Further, a category may include one or more subcategories, each of which may constitute a more specific division of type of products of the category. For instance, the one or more categories may include electronics and appliances, fitness and sports products, computers, and so on, each with subcategories such as home appliances and kitchen appliances, cardio equipment and running equipment, and laptops and desktops respectively. Accordingly, the hierarchy data may include an indication of the categorization and subcategorization of the products. Further, a level of the one or more categories, subcategories, products, and so on may be indicated in the hierarchy data. For instance, all product categories may be at an uppermost level and may be followed by one or more subcategories, all of which may be said to be at a second level. Further, the hierarchy data may include an indication of one or subcategories, sub-subcategories, products, and so on included in each category. For instance, the category of books may include the sub-categories of academic and non-academic books. Academic books may include further sub-subcategories representing a field of academia, and so on. Contrarily, non-academic books may include sub-subcategories of fiction and nonfiction, which may be further sub-sub-subcategorized, and so on. In an instance, the hierarchy data may be received through a user device, such as a server computer, used to host the hierarchy data. For instance, the server computer may host hierarchy data corresponding to an e-commerce platform, such as Amazon®.

Further, at 304, the method may include generating, using a processing device, a multi-panel UI based on the hierarchy data. The multi-panel UI may include a plurality of panels corresponding to the plurality of levels of the hierarchy. Each panel in the plurality of panels may comprise a visual depiction of a plurality of categories associated with a corresponding level of the hierarchy. Accordingly, the first level of hierarchy, comprising the plurality of categories may be depicted in a first panel through a plurality of blocks containing images and corresponding textual information. Further, interaction (such as through a click) with a block in the first panel in the multi-panel UI may lead to the revelation of a second panel of the multi-panel UI. The second panel may comprise a visual depiction of a plurality of sub-categories of the first category, which may be associated with a second level of the hierarchy. Further, upon revelation, the second panel may act as an active panel, and the first panel may act as an inactive panel. An active panel may be described as a panel that may, upon interaction with one or more blocks comprising the panel, may lead to the revelation of an additional panel corresponding to a lower level of the hierarchy. Conversely, interaction with an inactive panel corresponding to a higher level of hierarchy may lead to a progressive disappearance of one or more active and inactive panels (lower in hierarchy to the interacted panel), until the panel that may have been interacted with may be active. Accordingly, further panels of the multi-panel UI, each corresponding to a lower level of the hierarchy, may be revealed on interaction with an active panel, and one or more active and inactive panels (each corresponding to a subsequent higher level of hierarchy) may disappear on interaction with an inactive panel until the inactive panel is active.

Further, at 306, the method may include transmitting, using a communication device, the multi-panel UI to one or more user devices. In an instance, the one or more user devices may include electronic devices such as, for example, desktop computers, laptop computers, tablet computer, and mobile devices such as one or more smartphones, operated by one or more end users, wishing to purchase one or more products. Further, in an instance, the user devices may include devices that may host the hierarchy data and the generated multi-panel UI.

Further, at 308, the method may include receiving, using the communication device, a selection from a user device. The selection may correspond to a category in the plurality of categories of products, as represented through a block in the first panel in the multi-panel UI. Further, the first panel may be associated with a first level of the hierarchy. In an instance, the selection of the block may be received through an input mechanism of a user device of an end user for e.g. through a click of a mouse pointer, or a touch input through a touchscreen device. The user device may include, but may not be limited to a desktop computer, laptop computer, a tablet computer, a mobile device for e.g. a smartphone, or a wearable device for e.g. a smartwatch.

Further, at 310, the method may include transmitting, using the communication device the fading first panel and a second panel corresponding to a level of the hierarchy associated with the first selection. The selection of a block in the first panel may lead to the revelation of a second panel of the multi-panel UI. The second panel may comprise a visual depiction of a plurality of sub-categories of the first category, which may be associated with a second level of the hierarchy. Further, upon revelation, the second panel may act as an active panel, and the first panel may act as an inactive panel. As such, the inactivity of the first panel may be displayed through the fading of the first panel, and the prominence of the second panel. In an instance, the first panel may be colored in greyscale to indicate the inactivity, and to prominently indicate the selection of the second panel. An active panel may be described as a panel that upon interaction with one or more blocks comprising the panel, may lead to the revelation of an additional panel corresponding to lower level of the hierarchy. Conversely, interaction with the inactive panel (first panel) corresponding to the higher level of hierarchy may lead to a progressive disappearance of the active panel (second panel), until the panel that may have been interacted with (first panel) may be active.

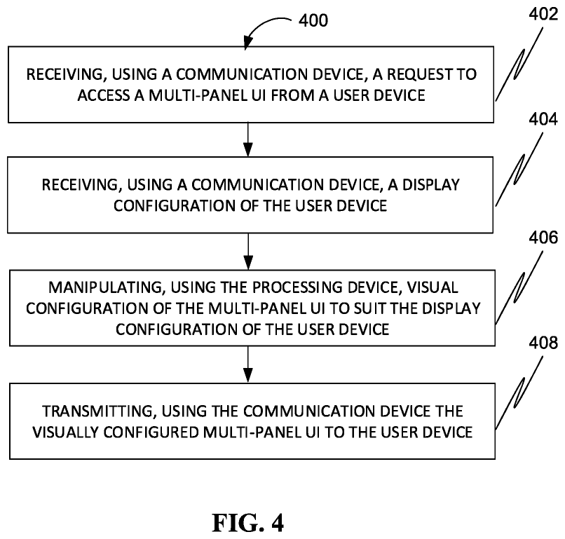

FIG. 4 shows a flowchart 400 of a method to configure a visual configuration of a multi-panel UI based on a display configuration of a user device, in accordance with some embodiments. Accordingly, at 402, the method may include receiving, using a communication device, a request to access a multi-panel UI from a user device. The multi-panel UI may include a plurality of panels corresponding to the plurality of levels of a hierarchy included in a digital content. The digital content may include details about one or more products, which may be available for purchase on an e-commerce platform, wherein the one or more products may correspond to one or more product categories and subcategories. A category of the one or more categories may represent a general collection of one or more products, which may be determined as having particular shared characteristics. Further, a category may include one or more subcategories, each of which may constitute a more specific division of type of products of the category. For instance, the one or more categories may include electronics and appliances, fitness and sports products, computers, and so on, each with subcategories such as home appliances and kitchen appliances, cardio equipment and running equipment, and laptops and desktops respectively. Accordingly, the digital content may include an indication of the categorization and subcategorization of the products. Further, a level of the one or more categories, subcategories, products, and so on may be indicated in the digital content. For instance, all product categories may be at an uppermost level and may be followed by one or more subcategories, all of which may be said to be at a second level. Further, the digital content may include an indication of one or subcategories, sub-subcategories, products, and so on included in each category. For instance, the category of books may include the sub-categories of academic and non-academic books. Academic books may include further sub-subcategories representing a field of academia, and so on. Contrarily, non-academic books may include sub-subcategories of fiction and non-fiction, which may be further sub-sub-subcategorized, and so on. Each panel in the plurality of panels in the multi-panel UI may comprise a visual depiction of a plurality of categories associated with a corresponding level of the hierarchy. Accordingly, the first level of hierarchy, comprising the plurality of categories may be depicted in a first panel through a plurality of blocks containing images and corresponding textual information. In an instance, the request to access the multi-panel UI may be received from a user device of an end user, such as a desktop computer, a laptop computer, a smartphone and so on. Further, the user device may include a display device that may display the multi-panel UI and may allow the end user to interact with the multi-panel UI.

Further, at 404, the method may include receiving, using a communication device, a display configuration of the user device. The display configuration of the user device may indicate a display specification of a display component, such as a screen of a smartphone, a monitor of a laptop computer, or an external monitor connected to a desktop computer, and so on. Accordingly, display configuration may include an indication of a display size of the display component, a display resolution of the display component, a refresh rate of the display component, a pixel density of the display component, and so on. In an instance, the display configuration of the user device may be automatically retrieved from the user device, such as through the BIOS of the user device. For instance, the user device may be a desktop computer, the display component of which may include a monitor with a 21-inch display that may have a display resolution of 1980*1080 and a pixel density of 581 pixels per inch.

Farther at 406, the method may include manipulating, using the processing device, visual configuration of the multi-panel UI to suit the display configuration of the user device. The manipulation may include changing the visual configuration of the one or more components of the multi-panel UI so as to display the components of the multi-panel UI in a configuration determined to be optimum with respect to the display configuration. For instance, the size of the one or more panels and size of the one or more blocks in the one or more panels may be manipulated and altered. Further, based on the display configuration, a number of one or more blocks represented in a row of a panel may be altered, along with the size of the one or more blocks. For instance, the number of blocks determined to be suitable to be displayed in a row of a panel of the multi-panel UI may be larger in a high-definition monitor of a desktop computer as compared to a display of a smartphone. Further, the size of blocks determined to be suitable to be displayed in a row of a panel of the multi-panel UI may be larger in a high-definition monitor of a desktop computer as compared to a display of a smartphone.

Further, at 408, the method may include transmitting, using the communication device, the visually configured multi-panel UI to the user device. The visually configured multi-panel UI may be transmitted to the user device, wherein, the multi-panel UI may be displayed through a display component of the user device.

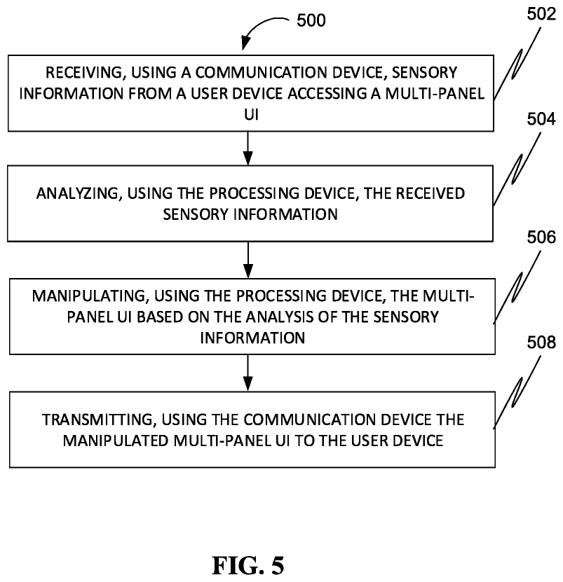

FIG. 5 shows a flowchart 500 of a method to manipulate a multi-panel UI based on a sensory information of a user device, in accordance with some embodiments.

Accordingly, at 502, the method may include receiving, using a communication device, sensory information from a user device accessing a multi-panel UI. The multi-panel UI may include a plurality of panels corresponding to the plurality of levels of a hierarchy included in a digital content. The digital content may include details about one or more products, which may be available for purchase on an e-commerce platform, wherein the one or more products may correspond to one or more product categories and subcategories. A category of the one or more categories may represent a general collection of one or more products, which may be determined as having particular shared characteristics. Further, a category may include one or more subcategories, each of which may constitute a more specific division of type of products of the category. For instance, the one or more categories may include electronics and appliances, fitness and sports products, computers, and so on, each with subcategories such as home appliances and kitchen appliances, cardio equipment and running equipment, and laptops and desktops respectively. Accordingly, the digital content may include an indication of the categorization and subcategorization of the products. Further, a level of the one or more categories, subcategories, products, and so on may be indicated in the digital content. For instance, all product categories may be at an uppermost level and may be followed by one or more subcategories, all of which may be said to be at a second level. Further, the digital content may include an indication of one or subcategories, sub-subcategories, products, and so on included in each category. For instance, the category of books may include the sub-categories of academic and non-academic books. Academic books may include further sub-subcategories representing a field of academia, and so on. Contrarily, non-academic books may include sub-subcategories of fiction and non-fiction, which may be further sub-sub-subcategorized, and so on. Each panel in the plurality of panels in the multi-panel UI may comprise a visual depiction of a plurality of categories associated with a corresponding level of the hierarchy. Accordingly, the first level of hierarchy, comprising the plurality of categories may be depicted in a first panel through a plurality of blocks containing images and corresponding textual information. Further, the sensory information may be received from a user device of an end user, such as a desktop computer, a laptop computer, a smartphone and so on that may be used to view and navigate the multi-panel UI. Sensory information may include information received from one or more sensors of the user device, such as an accelerometer, gyroscope, and so on, and may indicate one or more details about the user device, such as orientation, and movement of the user device.

Further, at 504, the method may include analyzing, using the processing device, the received sensory information. Analyzing the received sensory information may include determining a change in the orientation, or movement of the user device. For instance, if the user device is a smartphone, sensory information received from a gyroscope of the smartphone may indicate that the smartphone may have moved from a vertical orientation (portrait) to a horizontal orientation (landscape). Further, sensory information received from an accelerometer of the smartphone may indicate that the smartphone may have been shaken.

Further, at 506, the method may include manipulating, using the processing device, the multi-panel UI based on the analysis of the sensory information. In an instance, the manipulation of the multi-panel UI may include changing the visual configuration of one or more components of the multi-panel UI. For instance, the size of the one or more panels and size of the one or more blocks in the one or more panels may be manipulated and altered. Further, a number of one or more blocks represented in a row of a panel may be altered, along with the size of the one or more blocks. For instance, if the analysis of the sensory information indicates a change in the orientation of the user device from portrait to landscape, the horizontal display area may increase and the vertical display area may decrease. Accordingly, the number of blocks displayed in a row of a panel of the multi-panel UI may increase, and the number of blocks displayed in a column of a panel of the multi-panel UI may decrease. Further, if the sensory information corresponds to an input, the multi-panel UI may be manipulated to correspond to the input. For instance, when viewed on a smartphone, the multi-panel UI may be restored to the panel corresponding to a first level or hierarchy when shaken. Accordingly, if the analysis of the sensory information indicates shaking, the multi-panel UI may be restored to the panel corresponding to a first level or hierarchy.

Further, at 508, the method may include transmitting, using the communication device the manipulated multi-panel UI to the user device. The manipulated multi-panel UI may be transmitted to the user device, wherein, the multi-panel UI may be displayed through a display component of the user device.

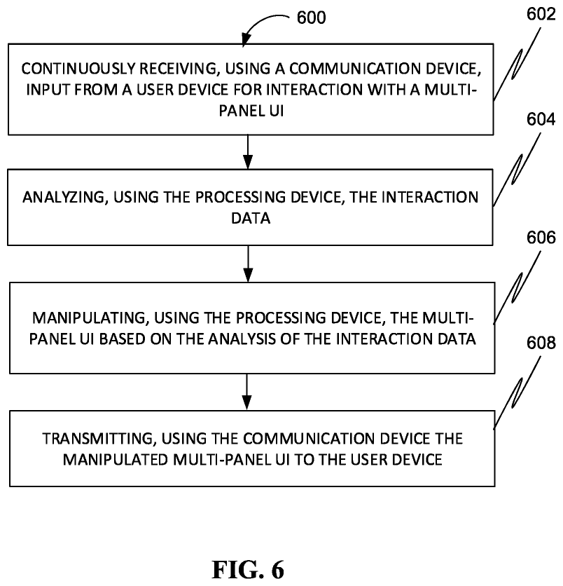

FIG. 6 shows a flowchart 600 of a method to manipulate a multi-panel UI based on analysis of interaction data, in accordance with some embodiments. Accordingly, at 602, the method may include continuously receiving, using a communication device, input from a user device accessing a multi-panel UI. The multi-panel UI may include a plurality of panels corresponding to the plurality of levels of a hierarchy included in a digital content. The digital content may include details about one or more products, which may be available for purchase on an e-commerce platform, wherein the one or more products may correspond to one or more product categories and subcategories. A category of the one or more categories may represent a general collection of one or more products, which may be determined as having particular shared characteristics. Further, a category may include one or more subcategories, each of which may constitute a more specific division of type of products of the category. For instance, the one or more categories may include electronics and appliances, fitness and sports products, computers, and so on, each with subcategories such as home appliances and kitchen appliances, cardio equipment and running equipment, and laptops and desktops respectively. Accordingly, the digital content may include an indication of the categorization and subcategorization of the products. Further, a level of the one or more categories, subcategories, products, and so on may be indicated in the digital content. For instance, all product categories may be at an uppermost level and may be followed by one or more subcategories, all of which may be said to be at a second level. Further, the digital content may include an indication of one or subcategories, sub-subcategories, products, and so on included in each category. For instance, the category of books may include the sub-categories of academic and non-academic books. Academic books may include further sub-subcategories representing a field of academia, and so on. Contrarily, non-academic books may include sub-subcategories of fiction and non-fiction, which may be further sub-sub-subcategorized, and so on. Each panel in the plurality of panels in the multi-panel UI may comprise a visual depiction of a plurality of categories associated with a corresponding level of the hierarchy. Accordingly, the first level of hierarchy, comprising the plurality of categories may be depicted in a first panel through a plurality of blocks containing images and corresponding textual information. Further, the input may be received from a user device of an end user, such as a desktop computer, a laptop computer, a smartphone and so on that may be used to interact with the multi-panel UI. Interaction with the multi-panel UI may include viewing and navigating (opening one or more panels and purchasing one or more products) the multi-panel UI through one or more inputs that may vary based on the user device.

Further, at 604, the method may include analyzing, using the processing device, the interaction data. The interaction data may be analyzed so as to determine a dexterity of the user in navigating the multi-panel UI. Dexterity in navigating the multi-panel UI may include accessing one or more desired panels and/or included blocks in a minimum possible number of interactions. For instance, if the interaction data indicates that multiple redundant interactions are made to navigate to a location that may be easily reachable, the user may be determined to be less dexterous in manipulating and using the multi-panel UI. Redundant interactions may include opening or closing of one or more panels multiple times without accessing a particular block.

Further, at 606, the method may include manipulating, using the processing device, the multi-panel UI based on the analysis of the interaction data. In an instance, the manipulation of the multi-panel UI may include changing the visual configuration of one or more components of the multi-panel UI. For instance, the size of the one or more panels and size of the one or more blocks in the one or more panels may be manipulated and altered. Further, a number of one or more blocks represented in a row of a panel may be altered, along with the size of the one or more blocks. For instance, if the analysis of the interaction data indicates a low level of dexterity of the user in navigating the multi-panel UI, the number of blocks displayed in a row of a panel of the multi-panel UI may decrease along with an increase in the size of the blocks. Further, if the analysis of the interaction data indicates a high level of dexterity of the user in navigating the multi-panel UI, the number of blocks displayed in a row of a panel of the multi-panel UI may increase along with an increase in the size of the blocks.

Further, at 608, the method may include transmitting, using the communication device the manipulated multi-panel UI to the user device. The manipulated multi-panel UI may be transmitted to the user device, wherein, the multi-panel UI may be displayed through a display component of the user device.

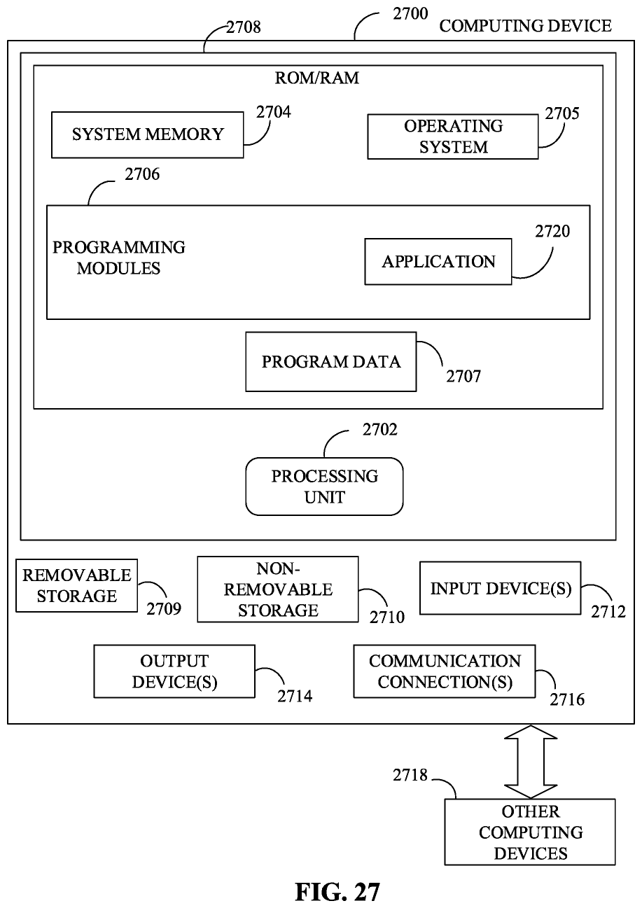

With reference to FIG. 27, a system consistent with an embodiment of the disclosure may include a computing device or cloud service, such as computing device 2700. In a basic configuration, computing device 2700 may include at least one processing unit 2702 and a system memory 2704. Depending on the configuration and type of computing device, system memory 2704 may comprise, but is not limited to, volatile (e.g. random-access memory (RAM)), non-volatile (e.g. read-only memory (ROM)), flash memory, or any combination. System memory 2704 may include operating system 2705, one or more programming modules 2706, and may include a program data 2707. Operating system 2705, for example, may be suitable for controlling computing device 2700's operation. In one embodiment, programming modules 2706 may include machine learning module. Furthermore, embodiments of the disclosure may be practiced in conjunction with a graphics library, other operating systems, or any other application program and is not limited to any particular application or system. This basic configuration is illustrated in FIG. 27 by those components within a dashed line 2708.

Computing device 2700 may have additional features or functionality. For example, computing device 2700 may also include additional data storage devices (removable and/or non-removable) such as, for example, magnetic disks, optical disks, or tape. Such additional storage is illustrated in FIG. 27 by a removable storage 2709 and a non-removable storage 2710. Computer storage media may include volatile and nonvolatile, removable and non-removable media implemented in any method or technology for storage of information, such as computer-readable instructions, data structures, program modules, or other data. System memory 2704, removable storage 2709, and non-removable storage 2710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2700. Any such computer storage media may be part of device 2700. Computing device 2700 may also have input device(s) 2712 such as a keyboard, a mouse, a pen, a sound input device, a touch input device, a location sensor, a camera, a biometric sensor, etc. Output device(s) 2714 such as a display, speakers, a printer, etc. may also be included. The aforementioned devices are examples and others may be used.

Computing device 2700 may also contain a communication connection 2716 that may allow device 2700 to communicate with other computing devices 2718, such as over a network in a distributed computing environment, for example, an intranet or the Internet. Communication connection 2716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2704, including operating system 2705. While executing on processing unit 2702, programming modules 2706 (e.g., application 2720 such as a media player) may perform processes including, for example, one or more stages of methods, algorithms, systems, applications, servers, databases as described above. The aforementioned process is an example, and processing unit 2702 may perform other processes. Other programming modules that may be used in accordance with embodiments of the present disclosure may include data processing application, machine learning application, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

What is claimed is:

1. A method to facilitate generation of a multi-panel UI based on a hierarchy data corresponding to a digital content, the method comprising:
receiving, using a communication device, the hierarchy data corresponding to the digital content from a computing device;
generating, using a processing device, the multi-panel UI based on the hierarchy data, wherein the multi-panel UI comprises a plurality of panels corresponding to a plurality of levels of hierarchy, wherein each panel of the plurality of panels comprises a visual representation of a plurality of categories associated with a corresponding level of hierarchy, wherein the multi-panel UI comprises a first panel corresponding to a first level of hierarchy and a second panel corresponding to a second level of hierarchy, wherein the first level of hierarchy is higher than the second level of hierarchy, wherein the multi-panel UI is configured for:
displaying a first form of the first panel based on a first panel selection input corresponding to the first panel;
displaying a first form of the second panel based on a second panel selection input corresponding to the second panel, wherein a second form of the first panel is configured to be displayed concurrently with the displaying of the second panel; and
displaying the first form of the first panel based on a first panel re-selection input corresponding to the first panel, wherein the displaying of the first form of the second panel is terminated based on the first panel re-selection input;
storing, using a storage device, the multi-panel UI; and
transmitting, using the communication device, the multi-panel UI to a user device, wherein the user device is configured to render the multi-panel UI.

2. The method of claim 1 further comprising receiving, using the communication device, at least one device characteristic associated with the user device, wherein the generating of the multi-panel UI is further based on the at least one device characteristic.

3. The method of claim 2, wherein the at least one device characteristic comprises a display size associated with the user device, wherein at least one of a number and a panel size associated with the plurality of panels of the multi-panel UI is based on the display size.

4. The method of claim 1, wherein the third panel selection input is based on a sensor data associated with at least one sensor comprised in the user device.

5. The method of claim 1, wherein the second form of the first panel comprises at least a portion of the first panel, wherein at least one first visual characteristic associated with the at least one portion is dynamically modified to be distinct from at least one second visual characteristic associated with the first form of the second panel.

6. The method of claim 1, wherein at least one first visual characteristic associated with the first form of the first panel is dynamically modified to be distinct from at least one second visual characteristic associated with the second form of the first panel.

7. The method of claim 1, wherein the multi-panel UI further comprises a third panel corresponding to a third level of hierarchy, wherein the second level of hierarchy is higher than the third level of hierarchy, wherein the multi-panel UI is further configured for:
displaying a first form of the third panel based on a third panel selection input corresponding to the third panel, wherein each of the second form of the first panel and a second form of the second panel is configured to be displayed concurrently with the displaying of the first form of the third panel; and
displaying the first form of the first panel based on the first panel re-selection input corresponding to the first panel, wherein the displaying of each of the first form of the second panel and the first form of the third panel is terminated based on the first panel re-selection input.

8. The method of claim 1, wherein the second form of the first panel comprises an invisible form of the first panel, wherein the displaying of the second form of the first panel is further based on detection of a condition.

9. The method of claim 1, wherein each of the first form of the first panel and the first form of the second panel comprise at least one of a search interfaces configured to receive a search query, a sorting interface configured to sort a plurality of categories associated with a corresponding panel, and a virtual shopping cart interface.

10. The method of claim 1, wherein the multi-panel UI further comprises a side bar configured to visually represent the plurality of levels of hierarchy based on at least one of the first panel selection input, the second panel selection input and the first panel re-selection input.

11. A system to facilitate generation of a multi-panel UI based on a hierarchy data corresponding to a digital content, the system comprising:
a communication device configured for:
receiving, using a communication device, the hierarchy data corresponding to the digital content from a computing device;
transmitting, using the communication device, the multi-panel UI to a user device, wherein the user device is configured to render the multi-panel UI,
a processing device configured for generating the multi-panel UI based on the hierarchy data, wherein the multi-panel UI comprises a plurality of panels corresponding to a plurality of levels of hierarchy, wherein each panel of the plurality of panels comprises a visual representation of a plurality of categories associated with a corresponding level of hierarchy, wherein the multi-panel UI comprises a first panel corresponding to a first level of hierarchy and a second panel corresponding to a second level of hierarchy, wherein the first level of hierarchy is higher than the second level of hierarchy, wherein the multi-panel UI is configured for:
displaying a first form of the first panel based on a first panel selection input corresponding to the first panel;
displaying a first form of the second panel based on a second panel selection input corresponding to the second panel, wherein a second form of the first panel is configured to be displayed concurrently with the displaying of the second panel; and
displaying the first form of the first panel based on a first panel re-selection input corresponding to the first panel, wherein the displaying of the first form of the second panel is terminated based on the first panel re-selection input; and
a storage device configured for storing the multi-panel UI.

12. The system of claim 11, wherein the communication device is further configured for receiving at least one device characteristic associated with the user device, wherein the generating of the multi-panel UI is further based on the at least one device characteristic.

13. The system of claim 12, wherein the at least one device characteristic comprises a display size associated with the user device, wherein at least one of a number and a panel size associated with the plurality of panels of the multi-panel UI is based on the display size.

14. The system of claim 11, wherein the third panel selection input is based on a sensor data associated with at least one sensor comprised in the user device.

15. The system of claim 11, wherein the second form of the first panel comprises at least a portion of the first panel, wherein at least one first visual characteristic associated with the at least one portion is dynamically modified to be distinct from at least one second visual characteristic associated with the first form of the second panel.

16. The system of claim 11, wherein at least one first visual characteristic associated with the first form of the first panel is dynamically modified to be distinct from at least one second visual characteristic associated with the second form of the first panel.

17. The system of claim 11, wherein the multi-panel UI further comprises a third panel corresponding to a third level of hierarchy, wherein the second level of hierarchy is higher than the third level of hierarchy, wherein the multi-panel UI is further configured for:
displaying a first form of the third panel based on a third panel selection input corresponding to the third panel, wherein each of the second form of the first panel and a second form of the second panel is configured to be displayed concurrently with the displaying of the first form of the third panel; and
displaying the first form of the first panel based on the first panel re-selection input corresponding to the first panel, wherein the displaying of each of the first form of the second panel and the first form of the third panel is terminated based on the first panel re-selection input.

18. The system of claim 11, wherein the second form of the first panel comprises an invisible form of the first panel, wherein the displaying of the second form of the first panel is further based on detection of a condition.

19. The system of claim 11, wherein each of the first form of the first panel and the first form of the second panel comprise at least one of a search interface configured to receive a search query, a sorting interface configured to sort a plurality of categories associated with a corresponding panel, and a virtual shopping cart interface.

20. The system of claim 11, wherein the multi-panel UI further comprises a side bar configured to visually represent the plurality of levels of hierarchy based on at least one of the first panel selection input, the second panel selection input and the first panel re-selection input.
